(19) United States
(12) Patent Application Publication
(10) Pub. No.: US 2018/0367629 A1
(43) Pub. Date: Dec. 20, 2018

(54) Platform and Related Process for Providing Push Notifications Via Unique Subscriber Applications

(71) Applicant: Develapp, LLC, Dallas, TX (US)

(72) Inventors: Michael Slosar, Cleburne, TX (US); David Alexander Nimon, Cleburne, TX (US); Scott Brandt, Cleburne, TX (US)

(21) Appl. No.: 16/009,314

(22) Filed: Jun. 15, 2018

Related U.S. Application Data
(60) Provisional application No. 62/522,507, filed on Jun. 20, 2017.
(60) Provisional application No. 62/527,352, filed on Jun. 30, 2017.

(51) Int. Cl. H04L 29/08; H04L 12/58

(52) U.S. Cl. CPC H04L 67/26; H04L 51/14

(57) ABSTRACT

The disclosed principles provide a platform providing subscribers the ability to send custom push notifications. The platform is application-based, using mobile applications for use on a mobile device. Subscribers are provided a subscriber-level application from the platform. That application could be customized for the subscriber, or the subscriber may have a given amount of customization in order to personalize their own application. Users of a subscriber's unique application download the application via the platform. The subscriber will have administrative access within that application, via user name and password, and can coordinate to whom push notifications may be sent. The subscriber can designate individual targets to receive those push notifications, or may create groups for receiving the push notifications. Users of that subscriber's application could be allowed to shop for the subscriber's products via their application, and can receive push notifications sent via the platform.

### CROSS-REFERENCE TO RELATED APPLICATIONS

The present disclosure is a non-provisional conversion of, and thus claims priority to, U.S. Provisional Patent Application Ser. No. 62/522,507, filed Jun. 20, 2017, and U.S. Provisional Patent Application Ser. No. 62/527,352, filed Jun. 30, 2017, the contents of both of which are incorporated herein by reference for all purposes.

### TECHNICAL FIELD

The present disclosure relates to distribution of notifications to mobile applications, and in particular to a unique platform for use in providing subscribing members with the ability to send custom push notifications via the platform to users of member applications.

### BACKGROUND

With the continued development and popularization of smart mobile devices such as smart telephones, various types of application programs have appeared, resulting in a significant increase in the usage of wireless resources. Among the increase in wireless resources is the increased use of such wireless smart mobile devices for the marketing of goods and services to potential consumers. Online stores have been around for quite some time, but these conventional approaches to online commerce simply occupy a website on the Internet and openly offer goods and services for sales. Thus, there was no ability to send notifications to potential consumers without something more specific to reach those consumers.

Online marketing for such websites was the next evolution for online commerce, and such marketing originally just provided the broadcasting of advertisements on various websites, such as banner advertisements. Online technology further evolved to permit some targeting advertising to potential consumers based on prior online habits, such as targeted advertisements via consumers' social media accounts. However, the ability to send push notifications to certain consumers still was lacking. As mobile application development continued, presenting online stores via mobile devices like smartphones became possible. For example, a merchant's online website could be presented as an application for download and installation on consumers' mobile devices. With this development, a merchant could now provide a global notification to consumers that had installed the mobile application of their online store or other type of business.

However, the ability to single out certain consumers via those mobile applications for receiving customized notifications was still lacking, beyond having to send notifications to a specific email address or telephone number of each consumer. But such an approach is tedious when notifications are intended for only a select group of consumers. Moreover, the sending of push notifications, rather than emails, is a quicker and more desirable means of quickly providing information to consumers; however, the ability to customize push notifications for only certain people, groups of people, and even certain levels of people within an organization, is not readily available. This is particularly the case when the people are personnel within an organization that has a number of different levels of participation. These include not only multilevel marketing organizations, but also corporate structures with multiple levels of employees or other personnel.

Also, aside for the conundrum of customizable push notification, the task of creating one's own unique online store is not a simple one. Not only can the creating of website for online stores be cost-prohibitive for many small or start-up businesses, but the creation of mobile applications that provide such online stores to consumers can be equally difficult. Still further, getting mobile applications approved for offer to consumers via larger application download sites, such as Apple's “iTunes Store,” Google's “Google Play” and Microsoft's “Microsoft Store,” is not always easy or accessible for smaller merchants. Accordingly, there is a need in the art for a platform for use in providing subscribing members of that platform with the ability to create their own unique application for offering products or services, as well as to send custom push notifications to select installers of their unique application via the platform, but which does not suffer from the deficiencies of conventional approaches. The present disclosure provides such a solution.

### SUMMARY

To overcome the deficiencies of the prior art, the disclosed principles provide for a platform for use in providing subscribing members of that platform with the ability to send custom push notifications via the platform. In an exemplary embodiment, the platform is an application-based platform, and in a more specific embodiment, the applications are mobile applications such as for use on a mobile device such as a cellular telephone. Using a platform in accordance with the disclosed principles, subscribers/members will be provided a subscriber-level application from the platform. That application could be customized for the subscriber, or the subscriber may have a given amount of customization and in order to personalize their application for their needs. In some embodiments, the subscribers can be independent business owner/operators. In other embodiments, the subscribers may be independent business owners within a multi-level marketing company. In yet other embodiments, the subscribers may be management-level employees or partners in a single, larger company having a plurality of similar subscribers. Moreover, subscribers in such a single company may be separated into distinct levels, with some subscribers being above other subscribers in the hierarchical arrangement of that company.

As each subscriber is provided their unique application, users of their applications will download the same or a version of the subscriber's application provided via the platform, but such users will not have the administrative rights in the application provided to the subscriber. For example, if the subscriber is a seller of beauty products, the subscriber will be provided an application from the platform. That subscriber will have administrative access within that application, for example, via user name and password, and can thus coordinate to whom push notifications may be sent. The subscriber can designate individual targets to receive those push notifications, or may create groups for receiving the push notifications. Users of that subscriber's application could be allowed to shop for the subscriber's products via their application, and can receive push notifications sent via the platform to the application. Various embodiments of sending such push notifications to users, as well as to other subscriber-members in some embodiments, will be discussed further below.

In one exemplary embodiment, the platform for providing custom push notifications implemented in accordance with the disclosed principles may comprise a plurality of applications each uniquely corresponding to a respective plurality of subscribers of the platform. In such an embodiment, each unique application of a corresponding subscriber is configured to be installed and executed on a computing device of said corresponding subscriber, and each of the plurality of applications is configured to be executed on computing devices of one or more users selectively installing one or more of the plurality of applications on their respective computing devices. The exemplary platform may also comprise a database configured to store a plurality of unique application tags and unique device IDs. Each application tag uniquely identifies respective ones of the plurality of applications, and unique device IDs each correspond to respective computing devices of all subscribers and users having one of the plurality of applications installed thereon. The platform may also comprise a processor configured to associate device IDs of computing devices having one of the plurality of applications installed thereon with the unique application tag for each computing device's installed application. Such a processor may be configured to receive a request for a push notification from a subscriber via their unique application, to identify one or more user computing devices having the requesting subscriber's unique application installed thereon using associations of the unique application tag assigned to the requesting subscriber's unique application and the unique device IDs, and then to cause the push notification to be sent to one or more of the identified user computing devices via the requesting subscriber's unique application installed thereon.

In more specific embodiments, the requesting subscriber's unique application installed on the one or more identified user computing devices receiving that push notification have been selectively configured to receive the push notification. In an even further specific embodiment, the selective configuration is actively provided by respective users of the one or more identified user computing devices receiving the push notification. In some embodiments, the requesting subscriber's unique application installed on the one or more identified user computing devices receiving that push notification are required to receive the push notification as a condition of being installed on the users' devices. In some embodiments of a platform as disclosed herein, the processor causes that push notification to be sent from a push notification service that is independent from the platform, for example, Microsoft's Azure cloud-based push service. In some embodiments, the processor causes the push notification to be sent to all of the identified user computing devices having the requesting subscriber's unique application installed thereon.

In some embodiments, each subscriber can create customized groups of users to receive a push notification via their unique application. In such embodiments, the subscriber can identify only certain computing devices having the requesting subscriber's unique application installed based on a selection provided to the platform by the subscriber via his unique application. The selected receivers of the notification may again be selected by the platform using the unique device IDs of computing devices having the subscriber's unique application installed thereon, based on the unique application tag for that application. In yet other embodiments, an entity at a level above the subscriber can elect to send a push notification to all or only certain selected subscribers, or all or only certain selected users of one or more subscribers, again using the unique device IDs and unique application tags as discussed above. In still further embodiments, each unique application provided under the platform may be configured to allow the subscribers of those applications to send invitations to potential users/consumers to download and install that subscriber's unique application. Such embodiments allow such targeted users to easily choose to download.

In other aspects, methods for providing custom push notifications are also disclosed herein. In one exemplary embodiment, such a method may comprise providing a plurality of applications each uniquely corresponding to a respective plurality of subscribers of said platform. Each unique application of a corresponding subscriber may be configured to be installed and executed on a computing device of said corresponding subscriber, and each of the plurality of applications may be configured to be executed on computing devices of one or more non-subscribing users selectively installing one or more of the plurality of applications on their respective computing devices. An exemplary method may also comprise storing a plurality of unique application tags, each application tag uniquely identifying respective ones of the plurality of applications, as well as storing unique device IDs, each unique device ID corresponding to respective computing devices of all subscribers and users having one of the plurality of applications installed thereon. Such methods may also include associating unique device IDs of computing devices having one of the plurality of applications installed thereon with the unique application tag for each computing device's installed application. Such methods may further include receiving a request for a push notification from a subscriber via their unique application, identifying one or more user computing devices having said requesting subscriber's unique application installed thereon using associations of the unique application tag assigned to said requesting subscriber's unique application and the unique device IDs, and then causing said push notification to be sent to one or more of the identified user computing devices via the requesting subscriber's unique application installed thereon.

### BRIEF DESCRIPTION OF THE DRAWINGS

The detailed description that follows, by way of non-limiting examples of embodiments, makes reference to the noted drawings in which reference numerals represent the same parts throughout the several views of the drawings, and in which:

FIG. 1 illustrates a high level block diagram illustrating some of the various capabilities of a platform constructed and implemented in accordance with the disclosed principles;

FIG. 2 illustrates a series of three screen shots of an exemplary application for use by a subscriber/member of a platform employing the disclosed principles;

FIG. 3 illustrates a high-level representation of a single subscriber targeting a single consumer among a large number of users/customers of his unique application;

FIG. 4 illustrates a high-level representation of a single subscriber targeting two distinct groups of consumers among a large number of users/customers of his unique application;

FIG. 5 illustrates a high-level representation of a single subscriber targeting all of the consumers/users that have downloaded his unique application;

FIG. 6 illustrates a high-level diagram representing an implementation of a platform in accordance with the disclosed principles where the platform is used to send a notification to all subscribers who each have their own unique application via the platform;

FIG. 7 illustrates a high-level diagram representing an embodiment where the platform is used to send a notification to only certain subscribers;

FIG. 8 illustrates another high-level diagram representing an embodiment where the platform as disclosed herein is used to send a “global” notification;

FIG. 9 illustrates a diagram representing a hierarchical organization where the pinnacle of the MLM company is able to push a notification down to all subscribers/members having their own unique applications within the platform;

FIG. 10 illustrates a diagram representing a hierarchical organization where the pinnacle of the MLM company is able to push a notification down to only certain selected subscribers/members via their unique applications within the platform;

FIG. 11 illustrates a diagram representing a hierarchical organization where the pinnacle of the MLM company is able to push a notification down to all subscribers/members, as well as all users/customers having one or more of the subscribers' unique applications on their computing devices;

FIG. 12 illustrates a diagram representing a different embodiment of a hierarchical organization where such a notification sent by the pinnacle of the MLM company skips all of the subscribers/members and only reaches all of the users/customers of any subscriber of the MLM company;

FIG. 13 illustrates a diagram representing a hierarchical organization where the pinnacle of the MLM company is able to push a notification down to only a certain group of subscribers;

FIG. 14 illustrates a diagram representing a hierarchical organization where a subscriber/member of the MLM company is able to push a notification down to all other subscribers/members directly underneath the sending subscriber;

FIG. 15 illustrates a diagram representing a hierarchical organization where a push notification sent via the disclosed platform by a subscriber/member within the hierarchically established organization;

FIG. 16 illustrates a diagram representing a hierarchical organization where the same subscriber-sender of FIG. 15 is able to create a custom group of targeted subscribers that may be either downline or upline from his position within the company;

FIG. 17 illustrates a diagram representing a hierarchical organization where a subscriber/member of the platform is able to push a notification down to all of that sending subscriber's customers that have downloaded and installed that sending subscriber's unique application;

FIG. 18 illustrates a diagram representing a hierarchical organization where a subscriber/member is able to push a notification upline to all other subscribers/members at a higher level than the sending subscriber;

FIG. 19 illustrates a diagram representing a hierarchical organization where a push notification sent via the disclosed platform by a subscriber/member within the hierarchically established organization, where the sending subscriber/member is able to create a custom group of desired upline subscriber targets for the notification;

FIG. 20 illustrates a series of screenshots (FIGS. 20A-20F) showing a Quick Send Message process in accordance with the disclosed principles;

FIG. 21 illustrates a series of screenshots (FIGS. 21A-21G) showing a Send Message Via Contacts process in accordance with the disclosed principles;

FIG. 22 illustrates a series of screenshots (FIGS. 22A-22F) showing a Send Public Message process in accordance with the disclosed principles;

FIG. 23 illustrates a series of screenshots (FIGS. 23A-23H) showing a Create/Add Contacts process in accordance with the disclosed principles;

FIG. 24 illustrates a series of screenshots (FIGS. 24A-24H) showing a Remove Contacts process in accordance with the disclosed principles;

FIG. 25 illustrates a series of screenshots (FIGS. 25A-25J) showing a Group Contacts process in accordance with the disclosed principles;

FIG. 26 illustrates a series of screenshots (FIGS. 26A-26J) showing a Group Remove Contacts process in accordance with the disclosed principles;

FIG. 27 illustrates a series of screenshots (FIGS. 27A-27I) showing a Group Delete process in accordance with the disclosed principles;

FIG. 28 illustrates a series of screenshots (FIGS. 28A-28B) showing a Notification Viewing process in accordance with the disclosed principles;

FIG. 29 illustrates a series of screenshots (FIGS. 29A-29D) showing a Corporate App Contacts process in accordance with the disclosed principles.

### DETAILED DESCRIPTION

In view of the foregoing, through one or more various aspects, embodiments and/or specific features or sub-components, the present disclosure is thus intended to bring out one or more of the advantages that will be evident from the description. The present disclosure makes reference to one or more specific embodiments by way of illustration and example. It is understood, therefore, that the terminology, examples, drawings and embodiments are illustrative and are not intended to limit the scope of the disclosure.

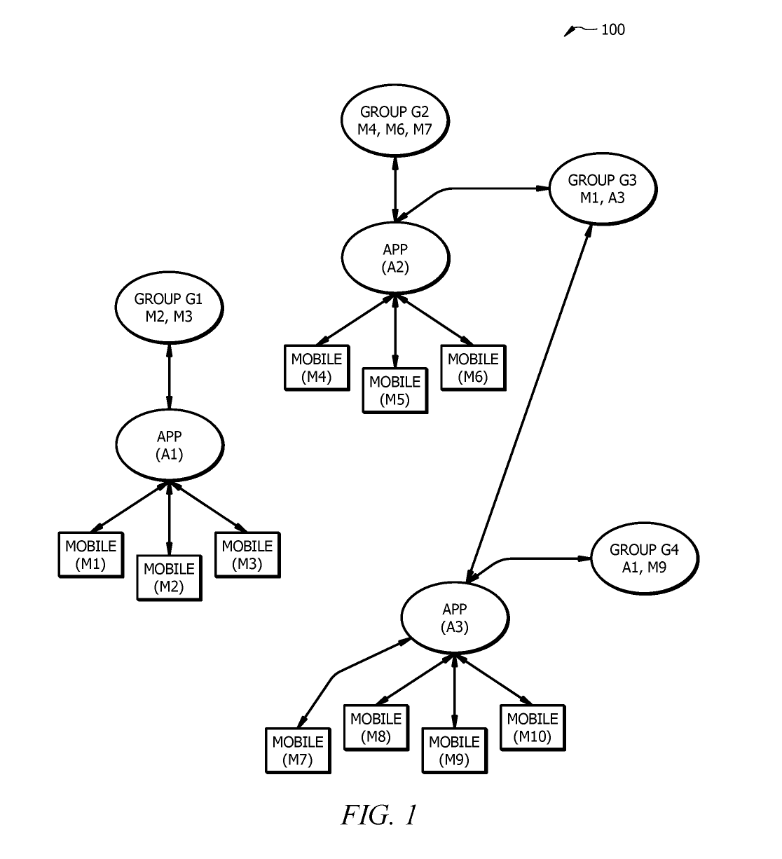

FIG. 1 illustrates a high level block diagram 100 illustrating some of the various capabilities of a platform constructed and implemented in accordance with the disclosed principles. As introduced above, a platform as disclosed herein includes a plurality of applications unique to each Subscriber of the platform. Depending on the implementation of the platform, Subscribers may be individuals offering something of value to prospective users/customers. Such things could be products and/or services offered by the Subscriber, or it could be information passed on to users by the Subscriber such as opinions or news elements. In other embodiments, the Subscribers may be independent business owners at various levels in a multi-level marketing enterprise, while the users are customers of one or more such Subscribers. In yet other embodiments, the Subscribers can be management personnel in various hierarchical levels of a company while the users may be the employees under one or more such Subscribers. Each of these embodiments is discussed in detail below.

FIG. 1 illustrates three unique applications (A1-A3), which are created for three distinct, corresponding Subscribers of the platform. In addition, each Subscriber then has a plurality of users (e.g., which could be consumers of the Subscriber's products/services) who have downloaded and installed one or more Subscribers' application onto their individual Mobile devices (M1-M10). Specifically, Mobile Devices M1-M3 are associated with users that have downloaded Subscriber Application A1, Mobile Devices M4-M6 are associated with users that have downloaded Subscriber Application A2, and Mobile Devices M7-M10 are associated with users that have downloaded Subscriber Application A3. Of course, any number of user may download a Subscriber's application, and may even download and install more than one such application.

In addition, FIG. 1 illustrates Groups (G1-G4) created by each of the Subscribers. In exemplary embodiments, these Groups are created by the Subscriber using their unique applications and the contacts list stored thereon. In some embodiments, a Group may be created by the platform, such as an administrator of the platform or a so-called “higher up” person or entity above one or more Subscriber in those embodiments where the platform is implemented in a hierarchical organization.

When a Subscriber creates one or more Groups for their own use in sending custom notifications, the Subscriber can indicate users (or even other subscribers) they want to add to the Group in their application. In the illustrated embodiment of FIG. 1, Group G1 was created for Subscriber Application A1 to include the users/consumers of mobile devices M2 and M3, Group G2 was created for Subscriber Application A2 to include the users/consumers of mobile devices M4, M6 and M7, Group G3 was created for Subscriber Application A1 to include the user/consumer of mobile device M1 but also the Subscriber of Application A3, and Group G4 was created for Subscriber Application A3 to include the user of mobile devices M9 as well as the subscriber of application A1.

As each Group is created, a new object may be created in the platform's database(s) to designate each such Group. Specifically, Application Tags associated with each unique Subscriber application and Device IDs associated with each unique mobile device are used to identify the designated members any particular Group. With the creation of such objects, the platform can quickly and easily identify which designated persons are to receive a notification by matching the unique Subscriber application and the unique Device ID of mobile devices that have downloaded that Subscriber's application. The platform can then push the desired notification to those mobile devices identified by their Device ID. In some embodiments, the platform may implement an independent push notification service/system to send the notification, one the target devices are identified and the content for the notification received from the person sending the notification.

In other embodiments, email addresses are used to identify persons and their devices for targeting for push notifications, rather than using Device IDs. In such embodiments, when the user downloads a Subscriber's application, the platform captures their email address or other type of unique identifier for each such downloader. The application tags may still then be used to identify each application downloaded from the platform by a user or member, and then target persons for notifications identified by matching the application tag(s) with the person's stored email address. Thus, instead of the notification(s) being sent using the Device IDs, the notification is sent to the matched email address, and thus can be received by the person on any device through which they have access to that email account. Other means of receiving notifications, such as through a social media account or SMS text message, may also be similarly employed by a platform according to the disclosed principles.

Also, a “global” notification may be sent through the platform, which would reach all users and subscribers that have downloaded and installed any of the unique subscriber applications from the platform, including the subscribers themselves. In some embodiments, receipt of notifications may be predicated on the user and/or subscriber “opting in” for receiving such notifications, for example, via a downloaded application associated with the platform. In some embodiments, the “opt in” choice may be for notifications sent by subscribers, whereas the global notifications may be received by all application installers, including subscribers, without the need to “opt in.” Of course, other opt in situations may also be employed, such as making opting in for all notifications a requirement to download and install a platform application, if desired.

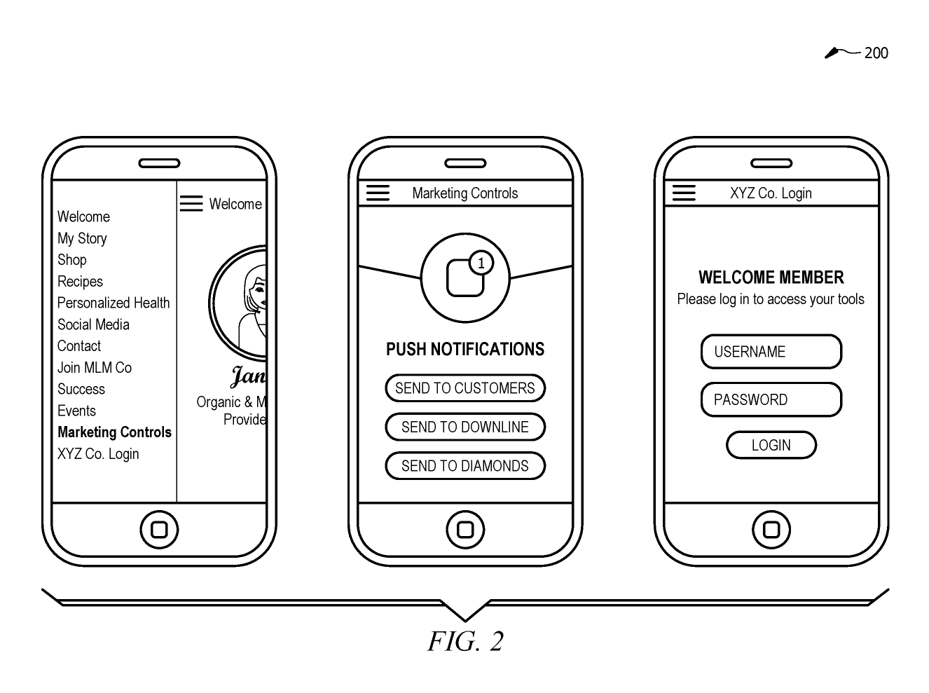

FIG. 2 illustrates a series of three screen shots 200 of an exemplary application for use by a subscriber/member of a platform employing the disclosed principles. While only an exemplary embodiment of a unique application created for a subscriber or “member” of the platform, these screen shots show a progression of three application screens such a member may navigate through to initiate the sending of a notification via their application. The first screen shot on the left of the figure presents a universal “welcome” screen for this exemplary application. Such a universal screen may be presented to all people who use the application, where it is the subscriber/member for which the application was created, or a user/consumer of that member. As such, this screens shot illustrates a number of links for navigating to other pages of the application that may be used by everyone, if desired. Other links presented on this initial application screen may only be for use by the subscriber/member or perhaps an employee of theirs, such as the company Login link and the Marketing Controls link.

The second application screen illustrated in FIG. 2 is the page that a member has navigated to through the selection of the “Marketing Controls” link on the Welcome screen. This exemplary page allows the member to send notifications via the application, which is then carried out by the platform. As illustrated, the member can choose to send a notification to the users/customers of their application, to other subscribers/members downline of him, for example, if the company is a MLM company or another organization with a hierarchical structure with employees underneath the member. A third option for sending notifications in this exemplary embodiment of an application is to send to a select group of people. In this example, the group is indicated as “Diamonds” as the members of the group have been determined previously based on performance of those persons, hence the “Diamond” designation. In other embodiments, this third option may be to send to any of a number of created groups, whether created by the company, by the platform, or by the subscriber/member himself. The third exemplary application screen is a login screen for the member, or perhaps an employee of the member's company, to login and gain access to other functions of the application limited to authorized persons only.

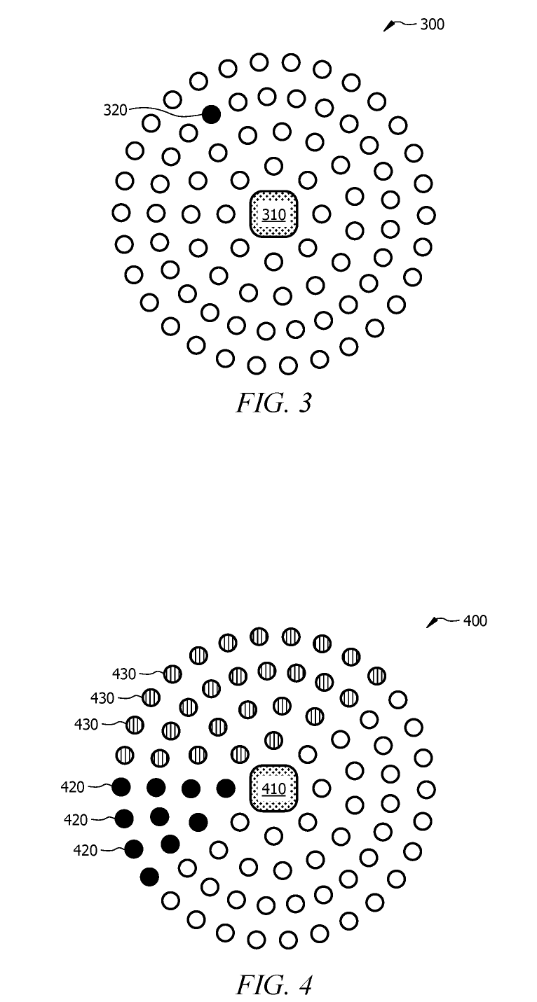

In addition to implementation in hierarchical organization arrangements, a platform in accordance with the disclosed principles may also be implemented in simple, single business owner-consumer arrangements. For example, the business owner would become a subscriber/member of the platform and thus sets up his unique application for his business through the platform. Consumers of his business may then download and install his unique application from the platform as well, or even from an online app store, such as the Apple® iTunes® store, the Google Play® app store, or Microsoft's® app store. Looking at FIG. 3, illustrated is a high-level diagram 300 representing of a single subscriber 310 targeting a single consumer 320 among a large number of users/customers of his unique application. In such embodiments, the single business owner/subscriber 310 can employ his unique application to send a notification to his users. In this illustrated embodiment, the subscriber 310 has selected a single user/consumer 320 to send a notification. As discussed above, the platform has previously associated a unique identifier of this user 320, such as the Device ID of the device used to download and install the subscriber's application, with the “tag” assigned to the subscriber's unique application. Thus, by matching these two stored items within the database(s) of the platform, the platform can cause the notification to be sent only to this selected consumer 320. Such an approach allows for pin-point marketing to specific consumers done via the subscriber's unique application.

Multiple users/consumers may also be targeted for the same notification. Once the subscriber 310 identifies one or more consumers/users for such targeted marketing, he can select those users via the push notification section in his application. As each consumer/user downloads and installs the subscriber's unique application, the platform records each user's computing device's unique Device ID or other unique identifier associated only with that user (e.g., phone number, email address, etc.), and then can associate that unique Device ID or other identifier with the application tag assigned to the subscriber's unique application. With this association, the platform can then easily target each selected user's computing device, phone number or account for the direct notification requested by the subscriber 310. Such a notification may be sent by the platform itself, or an independent push notification service can be instructed to deliver the specific content as discussed above.

In addition to individual targeted marketing, the disclosed platform also allows a subscriber to create various groups for targeted marketing. FIG. 4 illustrates a high-level diagram 400 representing of a single subscriber 410 targeting two distinct groups of consumers 420, 430 among a large number of users/customers of his unique application. In such embodiments, the subscriber 410, again through his unique application, can place certain consumers/users of his application in one or more groups. Then, using the technique described above for the individual targeted marketing, the subscriber 410 can have the platform send desired content to just those groups 420, 430, or even different content to different groups. FIG. 4 illustrates a small number of the subscriber's consumers designed in in one group 420, and a larger number of consumers designated in a second group 430, while about one-half of the subscriber's consumers are not in either of these groups. As such, the subscriber 410 may send distinct content to the two groups 420, 430 of consumers, while no such notifications are sent to the consumers not designated in these groups. When the subscriber 410 designates users for certain groups, the platform can simply match the unique application tag assigned to the subscriber's application with the unique IDs of each user, and then create a data object indicating that the identified users' ID (e.g., Device IDs) are part of a group. Then, when the subscriber 410 wants to send a notification to such created groups 420, 430, the platform simply identifies the Device ID or other unique user identifier for users in those groups and causes the group notification(s) to be sent to those unique user IDs. Also, users may be designated in more than one group, and thus can easily receive the content desired to be sent to each of the distinct groups as well. In such cases, the platform again simply associates the unique IDs for user(s) designated for multiple groups with the application tag, and then can quickly target the grouped user(s) for such group notifications.

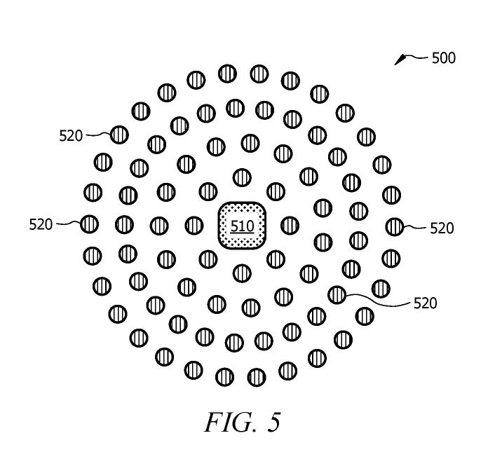

FIG. 5 illustrates a high-level diagram 500 representing of a single subscriber 510 targeting all of the consumers/users 520 that have downloaded his unique application. In embodiments with only a single subscriber 510, such a notification elected to be sent to the entire number of consumers/users 520 of that subscriber's application may be considered a “global” notification. To cause such a global notification to be sent, the platform simply identifies all unique user IDs, such as their Device IDs, associated with the subscriber's unique application tag.

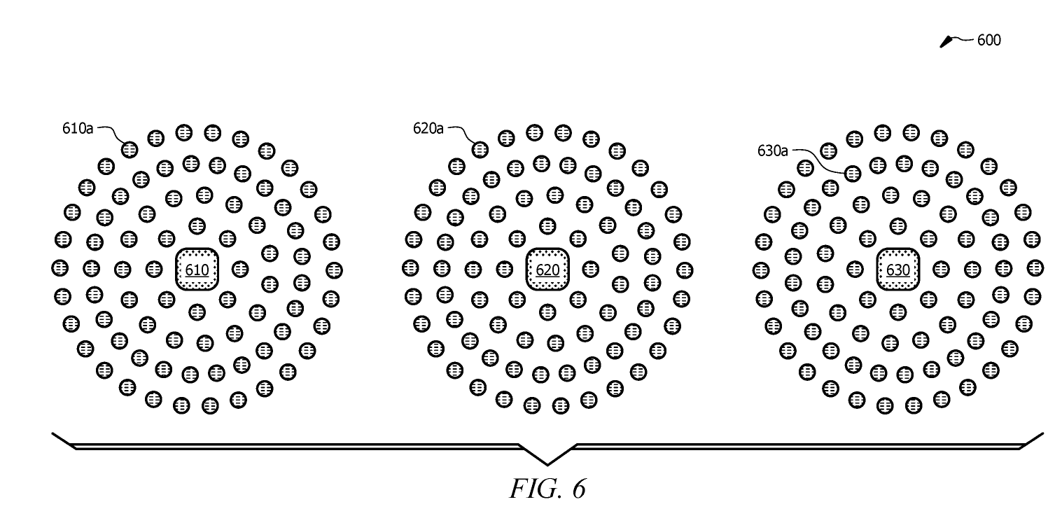

Looking now at FIG. 6, illustrated is a high-level diagram 600 representing an implementation of a platform in accordance with the disclosed principles where the platform is used to send a notification to all subscribers 610, 620, 630 who each have their own unique application via the platform. In such an embodiment, the collection of subscribers 610, 620, 630 may be related in some way, such as owners or managers of a single organization, or they may be unrelated subscribers simply being sent a single notification from the platform. However, in this illustrated embodiment, while each subscriber 610, 620, 630 has a large number of respective users 610a, 620a, 630a of their applications, to notification is only sent to the three subscribers 610, 620, 630.

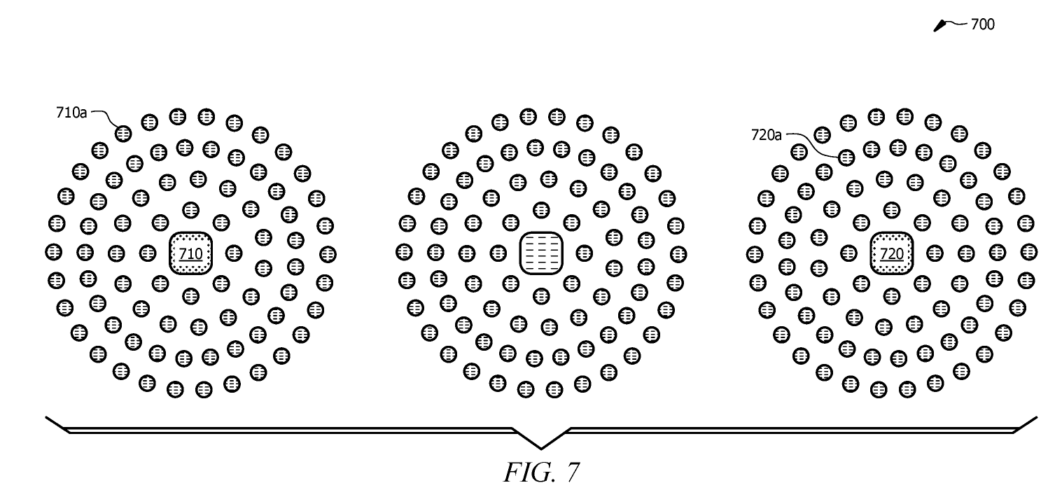

Alternatively, FIG. 7 illustrates a high-level diagram 700 representing an embodiment where the platform is used to send a notification to only certain subscribers 710, 720. Specifically, two subscribers 710, 720 out of three are shown to be selected for receiving a notification by the platform administration, or they could have been placed within a group created by a higher level entity or simply laterally across the platform from another subscriber not illustrated. However, as with FIG. 6, in this embodiment the users 710a, 720a of each subscriber are again not selected for receiving the notification.

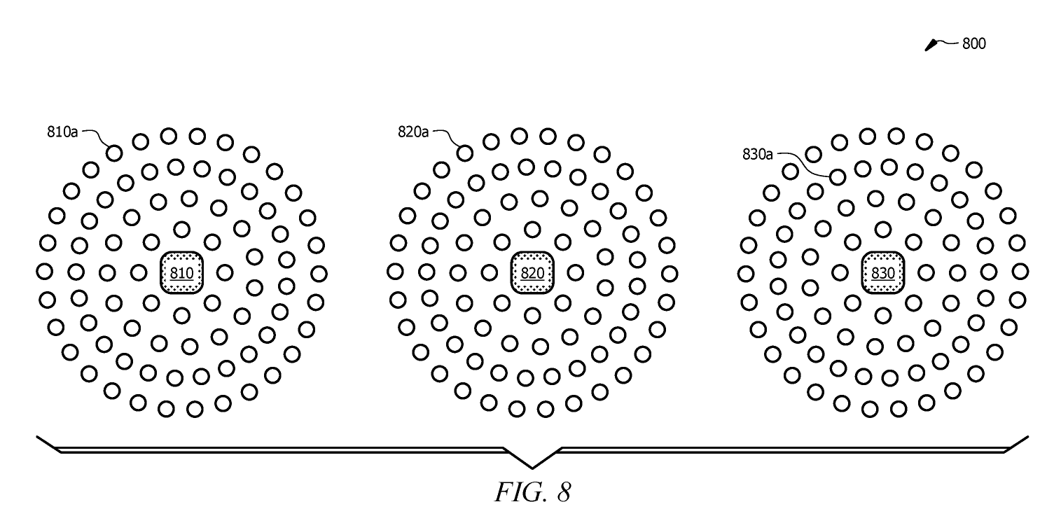

Turning to FIG. 8, illustrated is another high-level diagram 800 representing an embodiment where the platform as disclosed herein is used to send a “global” notification. Specifically, in this illustrated embodiment, three subscribers 810, 820, 830 are targeted for receiving a notification, as well as the numerous users/consumers 810a, 820a, 830a having installed each of those subscribers' respective applications. In other embodiments, the platform may be employed to send notifications to only the customers/users of all of the subscribers' respective applications, without the subscribers 810, 820, 830 themselves receiving those notifications.

By keeping an association of unique application tags with each subscriber's unique application and a unique ID, such as the Device IDs, for each subscriber and user of the platform, the platform can easily identify the computing device of any desired targets using a specific application, and cause notifications to be sent to only those specific devices via the application loaded on those devices. Thus, the disclosed platform provides the potential for notifications to be sent to any device installing a platform application, whether they are downline, upline or laterally sent. Moreover, such notification capabilities may also be selectively restricted to only one or more of a downline, upline or laterally sent notification, as desired for each subscriber and/or user. Still further, if users of the disclosed platform have more than one subscriber's unique application installed on their computing device, the platform can automatically detect this since the same device ID (or user account information) for a specific user will be associated or matched with more than one application tag in the platform's database records. Such capability is advantageous when the same global notification is sent through more than one subscriber whose application the user has installed (or sent on behalf of such multiple subscribers). In such a case, the platform can determine that only one such notification needs to be sent to the single device ID or unique user account, instead of the user being burdened with multiple instances of the same global notification through the multiple subscriber applications he has installed on his device. This is also the case for a notification sent to subscribers that have more than one unique application created under the platform, for example, for multiple distinct business ventures. As with the user with multiple installed applications, the platform can determine that the same subscriber's Device ID or account information is associated with multiple application tags, and thus only one copy of the notification needs to be sent to that subscriber, as opposed to the same notification appearing in the inbox of each of that subscriber's various platform applications.

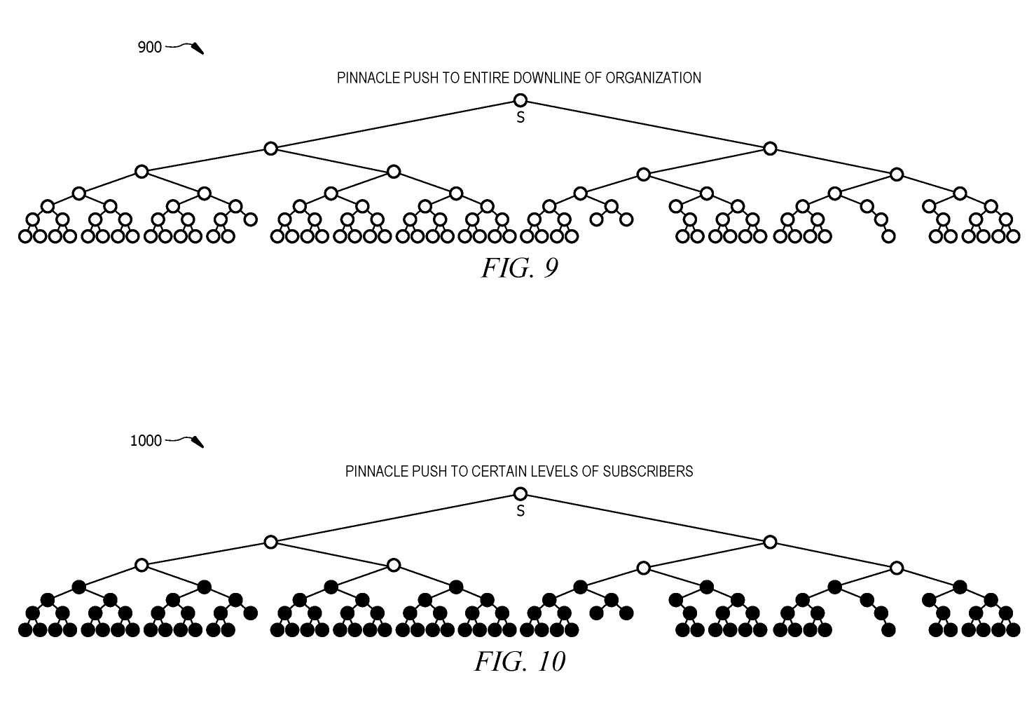

FIGS. 9-19 illustrate some of the various options for sending push notifications within an organization having a hierarchically arrangement for its members/employees, such as a Multi-Level Marketing (MLM) company, using a platform according to the disclosed principles. Other exemplary organizations in which the illustrated principles may be implemented could include law firms and other businesses having an express hierarchy of owner(s), principles, partners, associates, support staff and other employees. In these exemplary embodiments, the pinnacle of the figures may be the head (person or collection of persons, such as a Board of Directors) of the MLM or other hierarchically arranged company, and the dots beneath the pinnacle dot represent various levels of members/subscribers, who would each have their own unique application within the disclosed platform. In MLM embodiments, the members/subscribers would be the independent business operators (IBOs) selling products on behalf of the MLM at various levels of the hierarchy within the MLM. The customers or users are represented by the “C” blocks in the later figures, and these users are the customers of one or more of the D30 subscribers. In each figure, the sender desiring to send the notification is denoted by an “S” and the targeted receivers of that notification are the lightly shaded dots. The darkened dots are subscribers/members that would not receive the notification.

FIG. 9 illustrates a simplified diagram 900 representing a hierarchical organization where the pinnacle of the MLM company is able to push a notification down to all subscribers/members having their own unique applications within the platform. Such a notification would reach each of the various levels of subscriber-members, regardless of their place in the hierarchy of the company. As before, the platform identifies the desired target(s) of a notification by matching the tags assigned to each unique subscriber application and a unique member or use identifier, such as the Device ID for the computing devices used to install one or more such unique subscriber applications.

FIG. 10 illustrates a simplified diagram 1000 representing a hierarchical organization where the pinnacle of the MLM company is able to push a notification down to only certain selected subscribers/members via their unique applications within the platform. Such a notification could again reach subscribers at various levels of the hierarchy of the company, or could be targeted at only all subscribers at a specific level. Moreover, the pinnacle could send a notification to only subscribers at one or more lower levels, while skipping subscribers at higher levels, if desired.

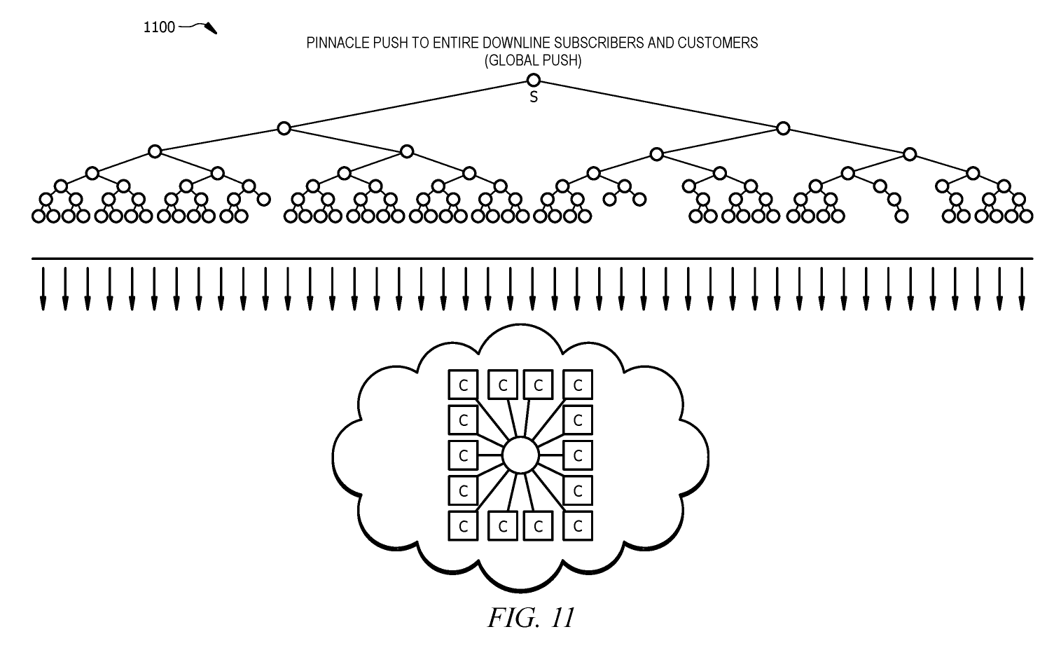

FIG. 11 illustrates a simplified diagram 1100 representing a hierarchical organization where the pinnacle of the MLM company is able to push a notification down to all subscribers/members, as well as all users/customers having one or more of the subscribers' unique applications on their computing devices. Such a “global” notification could reach each of the various levels of subscriber/members, regardless of their place in the hierarchy of the company, along with all of the customers of those subscribers.

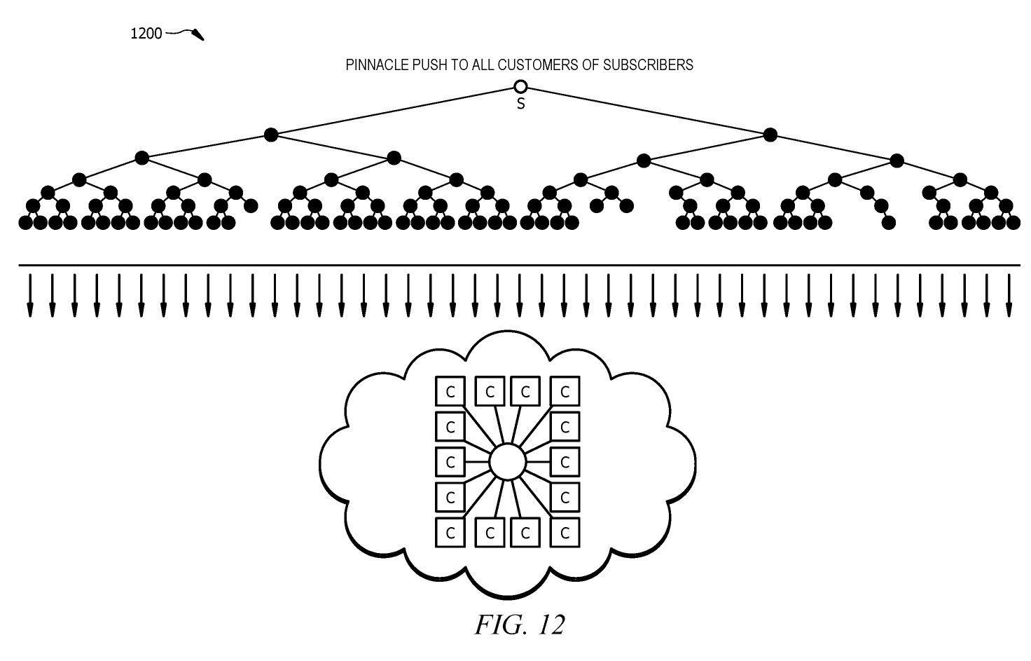

FIG. 12 illustrates a simplified diagram 1200 representing a different embodiment of a hierarchical organization where such a notification sent by the pinnacle of the MLM company skips all of the subscribers/members and only reaches all of the users/customers of any subscriber of the MLM company. Such an embodiment is advantageous in situations where the MLM company itself desires to send an advertisement or other notification to all of its customers, without interrupting any of the IBO subscribers with that notifications since they may not be consumers of the company's products. In related embodiments, only one or more level of subscribers/members may be skipped when the notification is sent, and thus is reaches all of the customers and some select level(s) of subscribers as well, perhaps to keep them informed of a company-wide sale or other similar notification being sent to all customers.

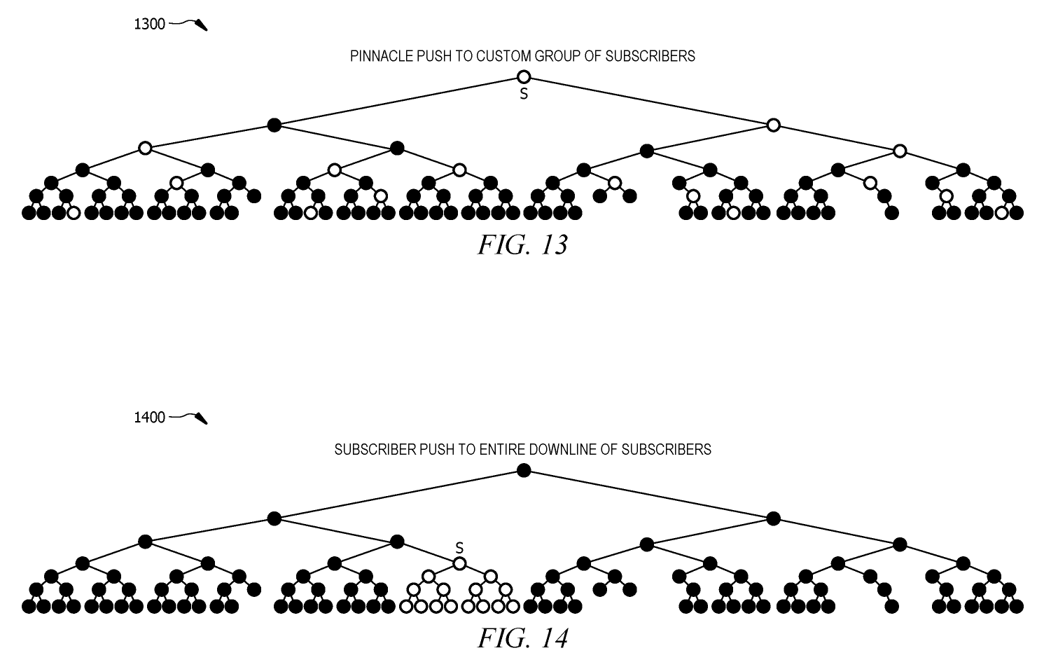

FIG. 13 illustrates a simplified diagram 1300 representing a hierarchical organization where the pinnacle of the MLM company is able to push a notification down to only a certain group of subscribers. Such a group may be created to include a number of subscribers at any of the various levels of the company, as illustrated, or the group may simply be defined by certain entire levels of subscribers within the company.

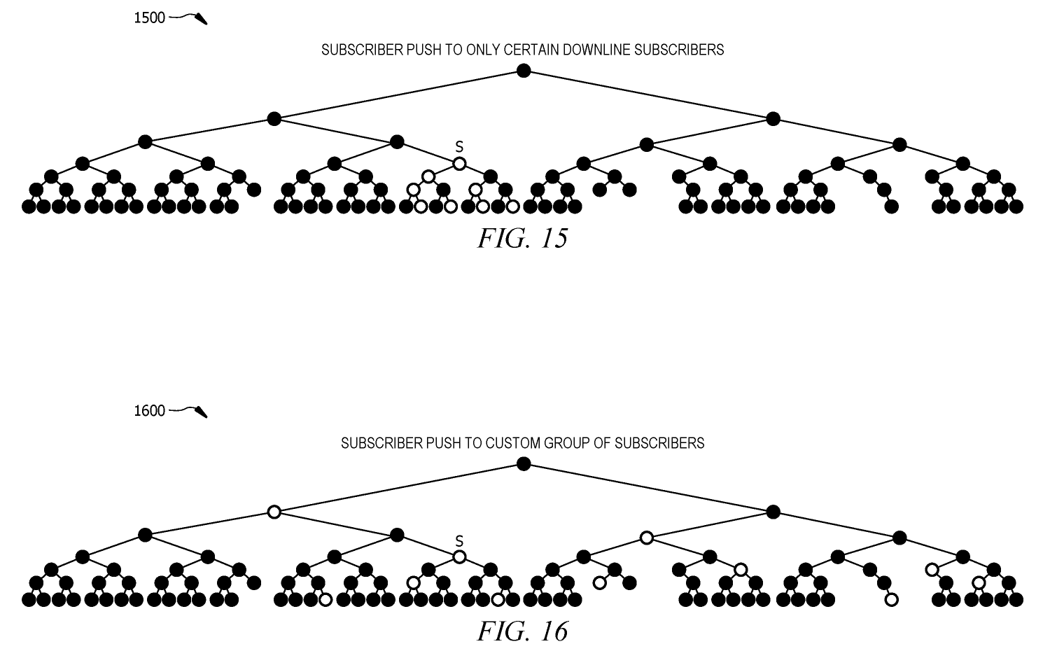

FIG. 14 illustrates a simplified diagram 1400 representing a hierarchical organization where a subscriber/member of the MLM company is able to push a notification down to all other subscribers/members directly underneath the sending subscriber. Such a notification may again reach each of the various levels of subscribers/members, regardless of their place in the hierarchy of the company, so long as they were underneath the sending subscriber. In a related implementation of the disclosed principles, FIG. 15 illustrates a simplified diagram 1500 representing a hierarchical organization where a push notification sent via the disclosed platform by a subscriber/member within the hierarchically established organization. However in this implementation, the sending subscriber/member is able to create a custom group of desired subscriber targets downline from the sending subscriber for such a notification. Thus, where FIG. 14 illustrated how a subscriber may cause a notification to be sent via the platform to all downline subscribers from his position in the hierarchy, FIG. 15 illustrates how that subscriber can customize the list of targeted recipients to include only certain subscribers downline from him.

FIG. 16 illustrates a simplified diagram 1600 representing a hierarchical organization where the same subscriber-sender of FIG. 15 is able to create a custom group of targeted subscribers that may be either downline or upline from his position within the company. Such ability may be given to the subscribers regarding any level of recipients, or it may be governed to prevent sending notifications too high up in the company, or perhaps to only upline and downline members within a certain department within the company. In short, any amount of tailoring of the ability to customize the group of targeted recipients within the organization can be provided with the disclosed platform. Also, such limiting can be configured to be done via one or more subscriber applications (e.g., the unique applications of higher-level subscribers, such as mangers or owners), such as preventing the inclusion of certain subscribers/members in a customized group in the first place. Or such a limitation may be configured within the platform itself, such the creation of objects to prevent sending certain targets from being included in a desired notification once those excluded subscribers are identified via the matching of application tag and Device ID or other unique identifier.

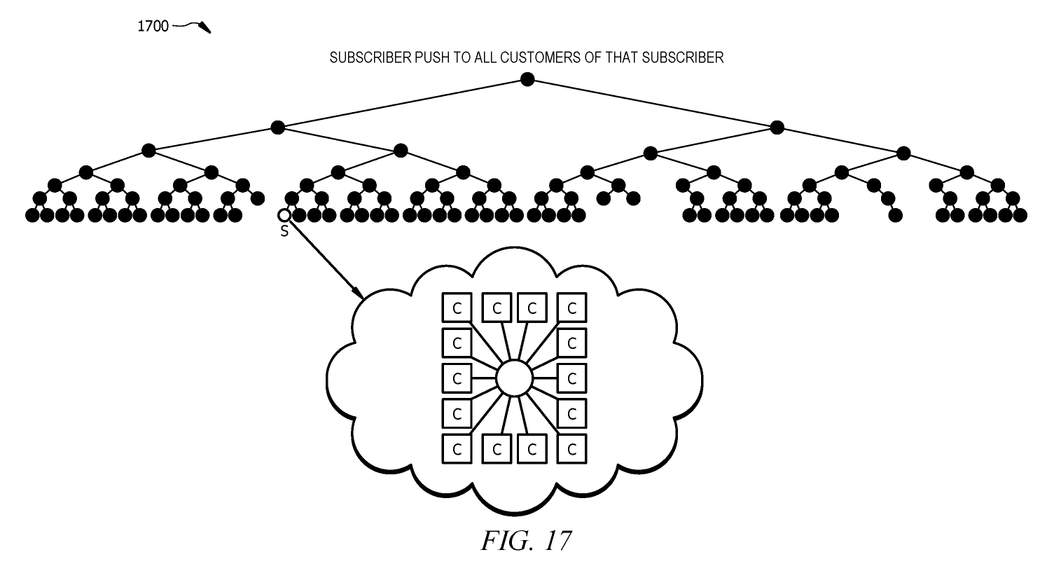

FIG. 17 illustrates a simplified diagram 1700 representing a hierarchical organization where a subscriber/member of the platform is able to push a notification down to all of that sending subscriber's customers that have downloaded and installed that sending subscriber's unique application. Such an implementation is advantageous when a subscriber desires to send a notification, such as an offer, to solely their customers and thus to the exclusion of other subscribers' customers.

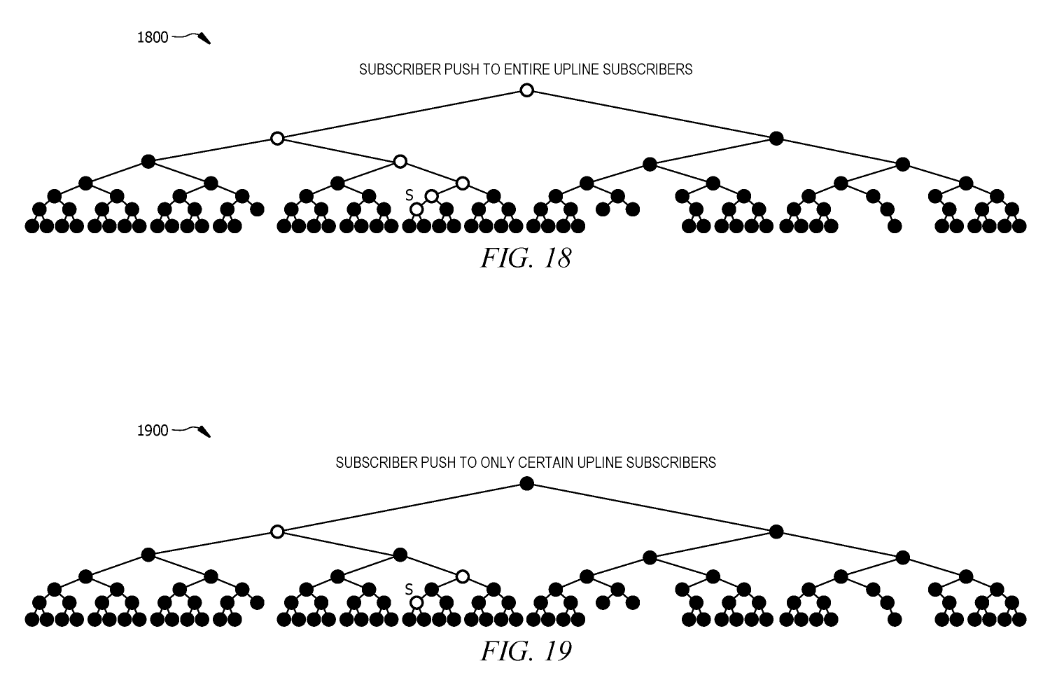

FIG. 18 illustrates a simplified diagram 1800 representing a hierarchical organization where a subscriber/member is able to push a notification upline to all other subscribers/members above (i.e., at a higher level) the sending subscriber. Such a notification may again reach each of the various levels of subscribers/members, regardless of their place in the hierarchy of the company, so long as they are upline of the sending subscriber. In a related implementation of the disclosed principles, FIG. 19 illustrates a simplified diagram 1900 representing a hierarchical organization where a push notification sent via the disclosed platform by a subscriber/member within the hierarchically established organization; however, in this implementation the sending subscriber/member is able to create a custom group of desired upline subscriber targets for the notification. Thus, where FIG. 14 illustrated how a subscriber may cause a notification to be sent via the platform to all upline subscribers from his position in the hierarchy, FIG. 19 illustrates how that subscriber can customize the list of targeted recipients to include only certain subscribers upline from him.

Additionally, in embodiments where the disclosed principles are implemented within an MLM, law firm, or other organizations having a hierarchical structure, a platform and related technique for sending notifications provide a number of distinct advantages over conventional approaches. For example, the platform and its unique created applications integrates with MLM companies or other similar organizations' back office tools. In addition, the disclosed principles provide an independent customer facing application for every member of the organization allowing each member to independently target and notify their own customers separate from other members' customers. Moreover, the platform and its applications seamlessly integrates with MLM companies' genealogy database. Deploying using a platform according to the disclosed principles also provides full support and management for each member's unique application. Also, use of a disclosed platform is completely scalable, from an individual business owner, to a large hierarchically arranged organization with thousands of personnel in various levels. Deployment is similarly flexible, with new applications easily created and made available at any time, without the requirement, but still the option, to create all member applications at the same time. Large companies implementing applications with a disclosed platform may also maintain control over the sending of notifications from any one or all such applications, as desired. And if a member leaves or sells their business, their unique application is also easily transferrable to a new member.

It should also be noted that the above-disclosed principles with regard to an MLM or similarly arranged company may also be implemented with any organizations that include a hierarchical structure as their organizational arrangement. For example, as discussed above, many law firms are organized with an internal hierarchy with a managing partner or managing committee at the pinnacle, equity partners having an ownership interest, then non-equity partners without an ownership interest, senior associates that work underneath certain partners, junior associates also working under certain partners, paralegals working under certain attorneys (both associates and/or partners), and then support staff within the office(s). Accordingly, a platform in accordance with the disclosed principles may be implemented for sending notifications within the hierarchy of such a law firm, using the various embodiments discussed above for MLM companies.

In such an embodiment, each of the owners/partners/employees of the law firm will have download and installed the same application on each of these computing devices, such as their mobile telephones. In some implementations, the managing partner or managing committee may be registered as the subscribers, and thus have the ability to send notifications to other people within the firm either selectively or globally. In some implementations, all partners may be subscribers, or the managing partner(s), equity partners and non-equity partners may each be subscribers and thus each have the ability to send notifications downline, laterally, or even up the line if that capability is enabled. Also, such subscribers may also be hierarchically established based on their level of partnership within the firm, with push notification capability corresponding to their level of partnership. As such, a given partner may send push notifications to each of the associates under them, as well as paralegal and/or staff in addition to or alternatively to sending to the associates. Similarly, upper level partners may be able to push notifications laterally to other partners or to lower level partners under them. Accordingly, a platform and associated notification process in accordance with the disclosed principles may be implemented in any company or other organization that has a hierarchical owner/employee arrangement.

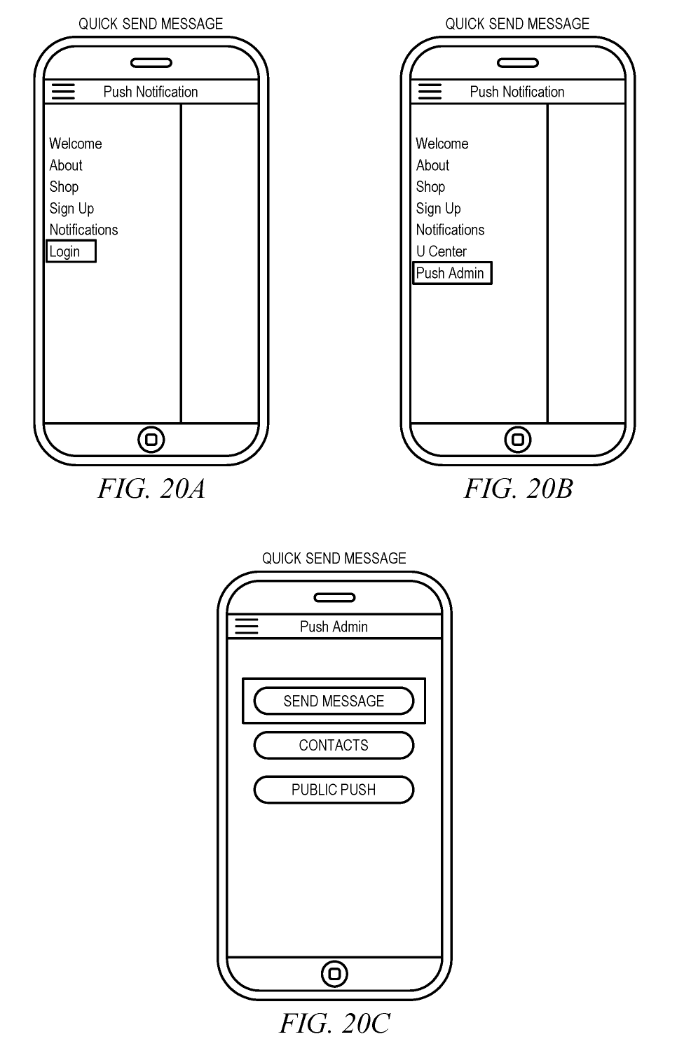

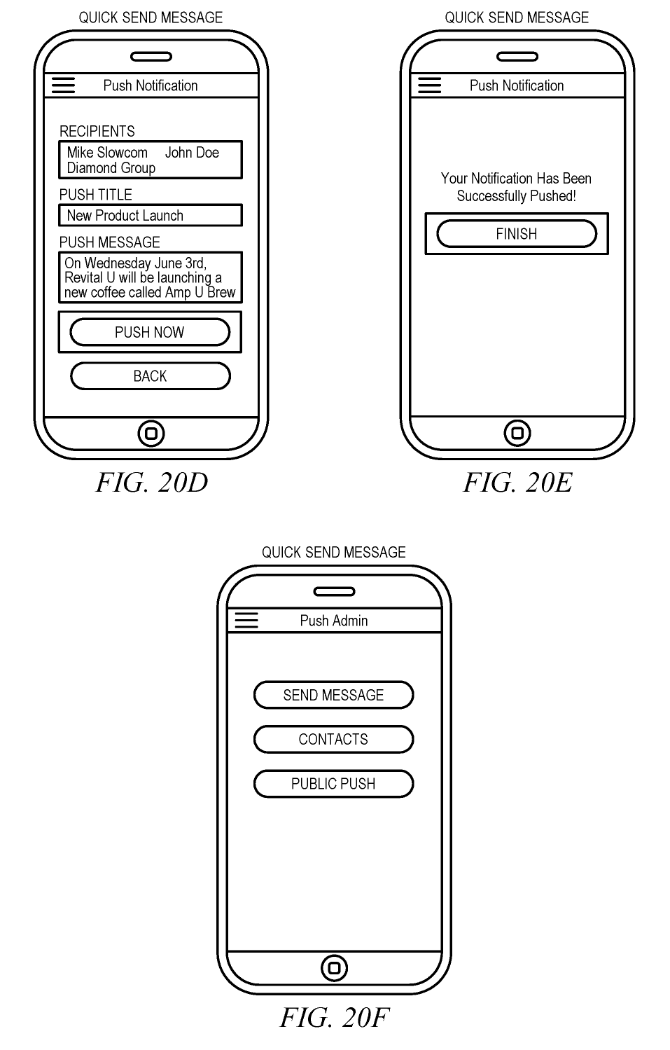

Turning finally to FIGS. 20-29, illustrated is a series of exemplary screen shots for distinct exemplary processes of sending messages/notifications via applications under a platform according to the disclosed principles. These processes are labeled on each of the collections of screenshots for each figure, and for each collections of screenshots, the individual processes are displayed on a screenshot-by-screenshot basis stepping through each of the illustrated processes.

Specifically, FIG. 20 illustrates a series of screenshots 20A-20F showing a Quick Send Message process. For the login screen of FIG. 20A, when a user of the application selects “Login” from the main menu, they will be prompted to input their credentials. These credentials will be matched against the subscriber database to determine if they are a subscriber of the platform. If they are a subscriber for that application tag, then the platform will load the Admin menu page(s), such as the screen shot of FIG. 20B. From this screen shot, the subscriber may then select the “Push Admin” or similarly named option to send a push notification in accordance with the disclosed principles. On the screen shot of FIG. 20C, the subscriber selects the “Send Message” option to send a message to only one or more selected users (or even other subscribers) of the sending subscriber's application. If the sending subscriber instead opts to send a “Public Push,” their message would be pushed down to every Device ID associated in the platform with the installation of the sending subscriber's application, which is discussed in further detail below.

Looking at the screen shot of FIG. 20D, the sending subscriber is able to enter the list of intended recipients when the sending subscriber selected the “Send Message” option form the screen of FIG. 20C. In advantageous embodiments, as the sending subscriber enters each recipient, the application can autocheck to see if recipient names being entered match recipients in the Contacts list, and thereby autofill any such names. Also, the application could be configured to work with the platform to interface with the database to autocheck if recipient names being entered are in fact installers of the sending subscriber's application. After the recipient names are entered, the sending subscriber can then enter a title for the message, as well as the content of the message to be sent. Once all fields are completed, the sending subscriber can select “Push Now” to send the message, or select “Back” to go back without sending the message. FIG. 20E illustrates a screen shot of the application where successful sending of the message is confirmed, and where the sending subscriber can select “Finish” to complete the push notification sending process. FIG. 20F provides a screen shot of the application returning back to the Push Admin screen previously discussed.

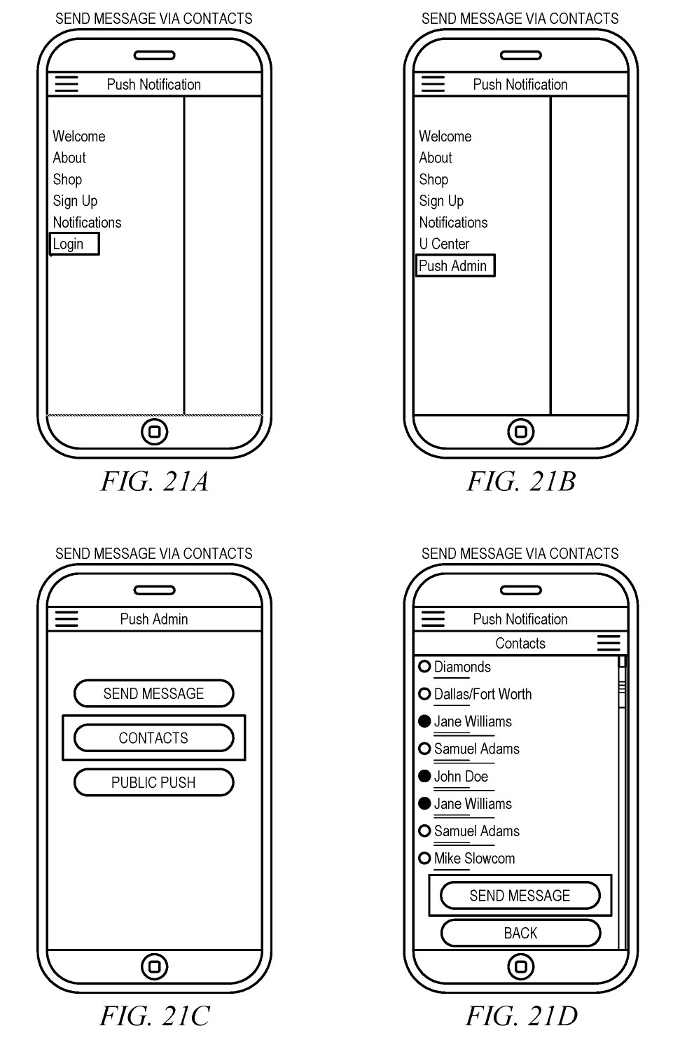

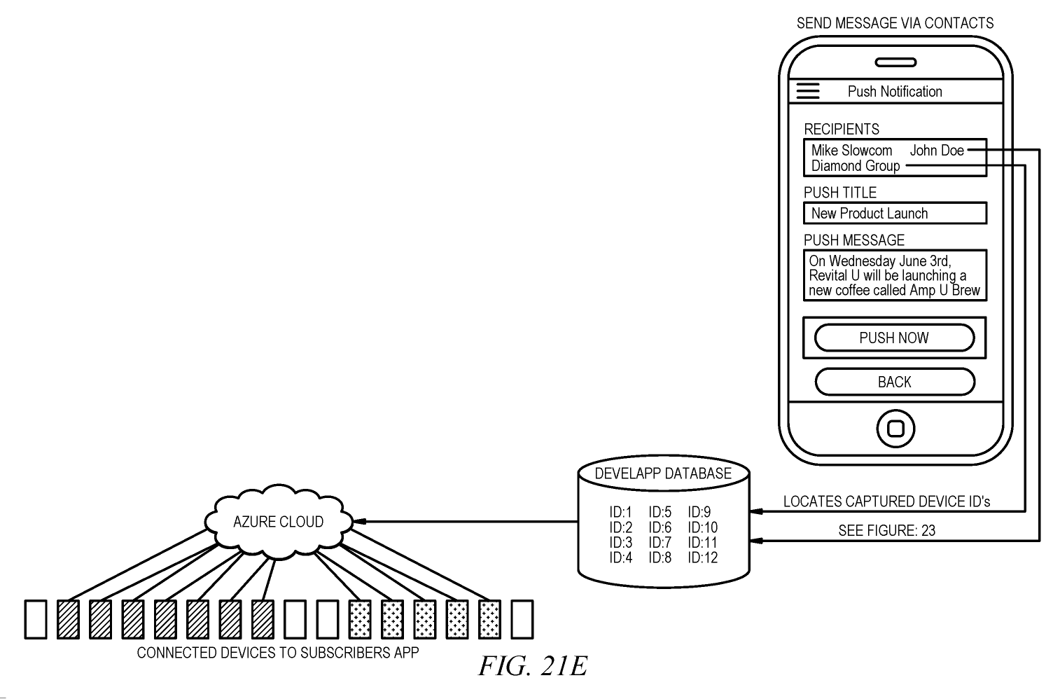

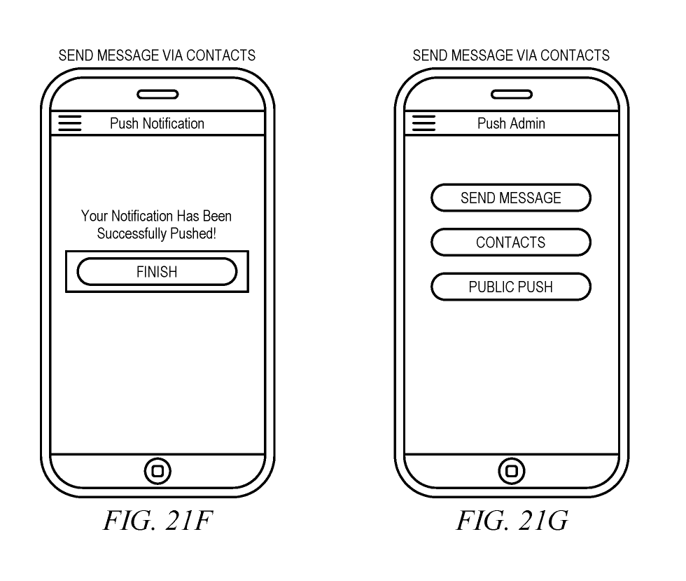

FIG. 21 illustrates a series of screenshots 21A-21G showing a Send Message Via Contacts process. Initially, after again entering credential using the login option in the screen shot of FIG. 21A, the sending subscriber would select from the Push Admin screen (FIG. 21B) to send a message via recipients selected from his Contacts list by selecting the “Contacts” option from the screen shot if FIG. 21C. The sending subscriber may then scroll through his contacts list, as shown in the screen shot of FIG. 21D, and select those he intends as recipients. After the selected recipients from the contact list are chosen, the sending subscriber selects “Send Message” and individual users and/or other subscribers having the sending subscriber's unique application installed on their device are autofilled in the Recipients box as shown in FIG. 21E.

In accordance with the disclosed principles, the disclosed platform accesses one or more databases to locate captured Device IDs associated with the application tag assigned to the subscriber's unique application. As illustrated, some Device IDs may be associated with users having installed the sending subscriber's unique application, while others may be associated with other subscribers having installed the sending subscriber's unique application. Once the appropriate Device IDs matched with the appropriate application tag have been identified, these Device IDs may then be provided, along with the content of the push notification to be sent by the sending subscriber, to an external push notification system, such as the illustrated Microsoft's Azure® Cloud. Of course, other push notification systems, including one internal to the disclosed platform, may also be employed to send the targeted push notification to the identified Device IDs. The process may again be finished by selecting the “Finish” option from the screen shot of FIG. 21F, and thereafter the application may again return to the Push Admin screen as shown in FIG. 21G.

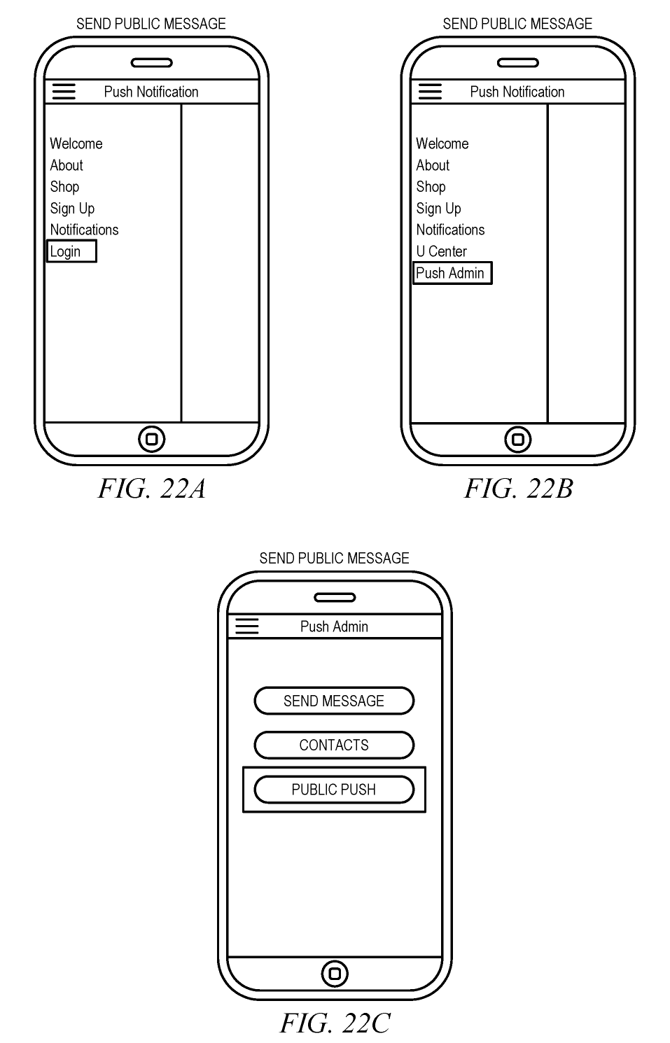

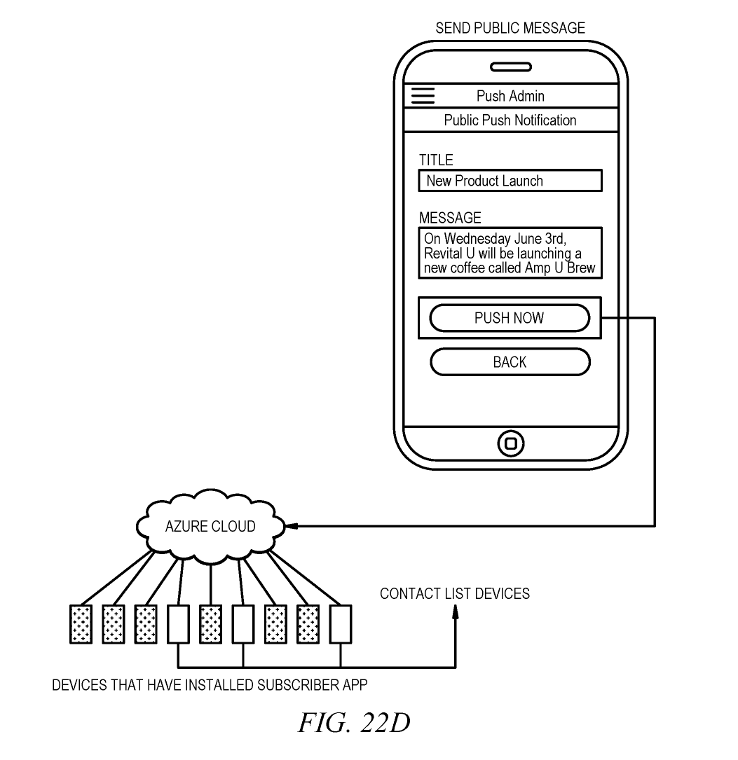

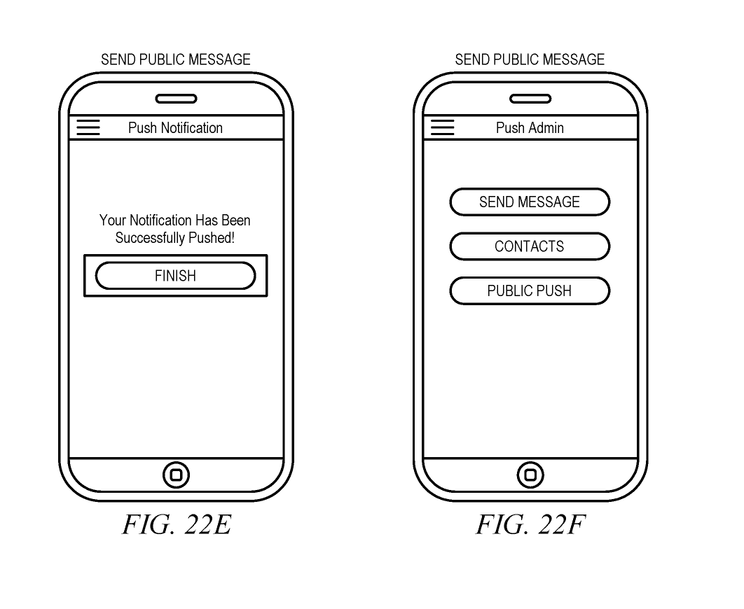

FIG. 22 illustrates a series of screenshots 22A-22F showing a Send Public Message process. Such a public push message, also called herein a “global notification,” is a push notification that is sent to all users and/or subscribers having installed the sending subscriber's unique application on their respective devices. As in the prior processes discussed above, sending subscriber logs into the application, again selects the Push Admin option, and then selects the “Public Push” option, all from FIGS. 22A-22C. Since all users/subscribers having the sending subscriber's unique application installed are the intended recipients, the screen shot of FIG. 22D does not include a “Recipients” box as before. However, on this screen the sending subscriber again may enter a title for the message, as well as the body of the message, in the corresponding boxes. As mentioned before, the disclosed platform determines the Device IDs of all such “global” or “public” users, and thereafter may again employ an external push notification system, such as the illustrated Microsoft's Azure® Cloud, to send the public or global push notification to the identified Device IDs. Moreover, such a global push notification may also be configured within the disclosed platform to push the global message to all users and/or subscribers having any subscriber applications installed on their devices. In such embodiments, the platform can simply determine the Device IDs of all devices having installed any subscriber applications from the platform thereon. The process may again be finished by selecting the “Finish” option from the screen shot of FIG. 22E, and thereafter the application may again return to the Push Admin screen as shown in FIG. 22F.

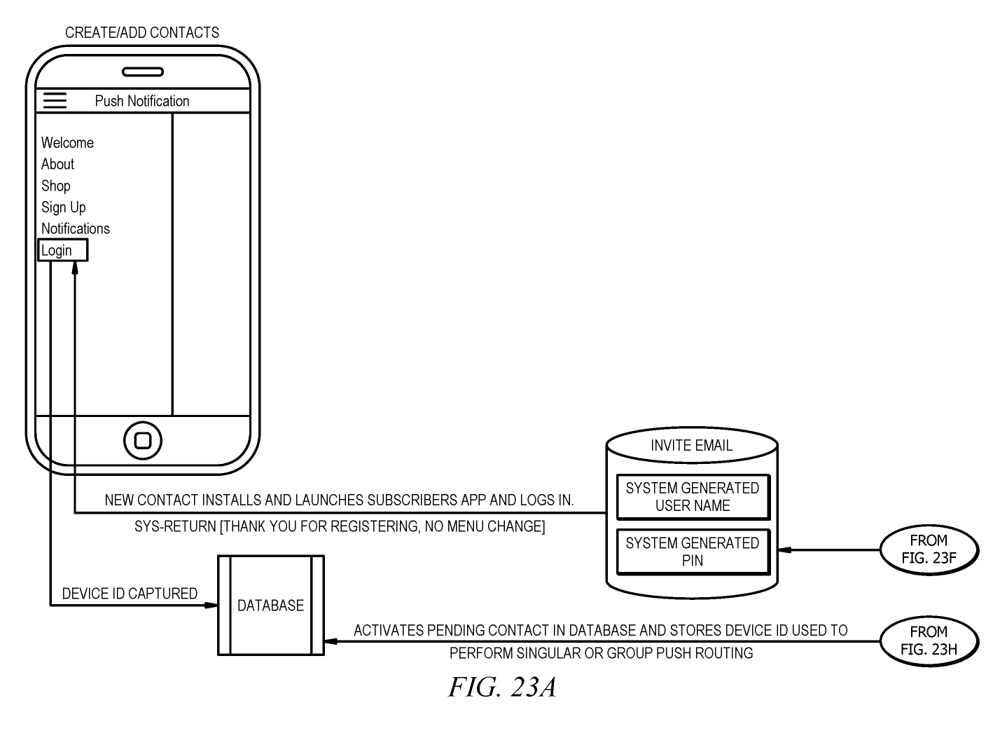

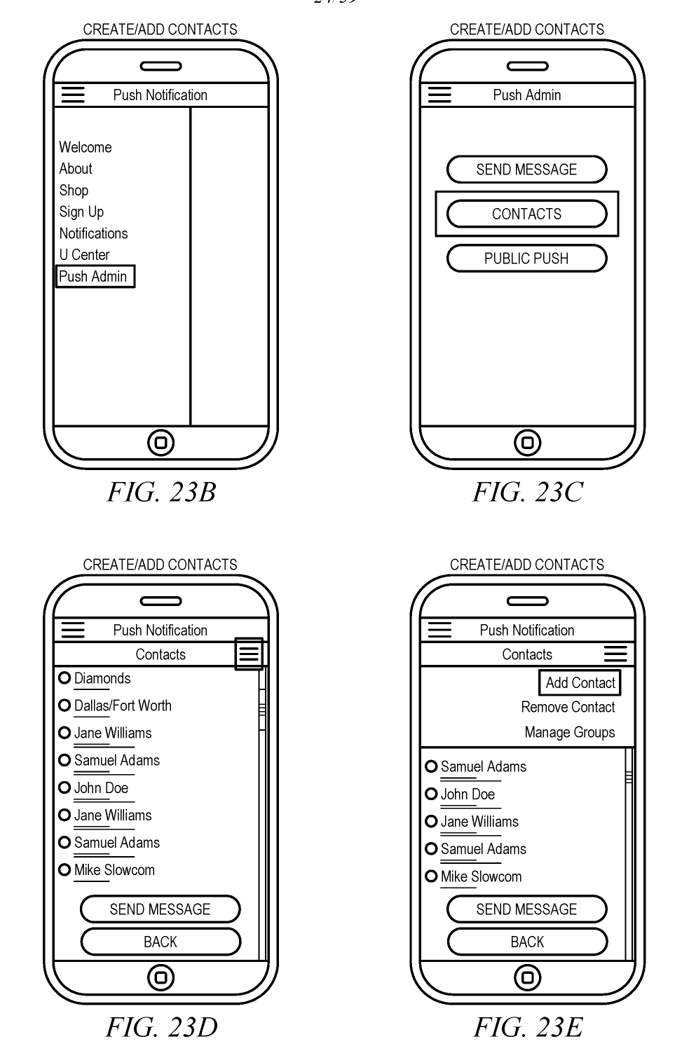

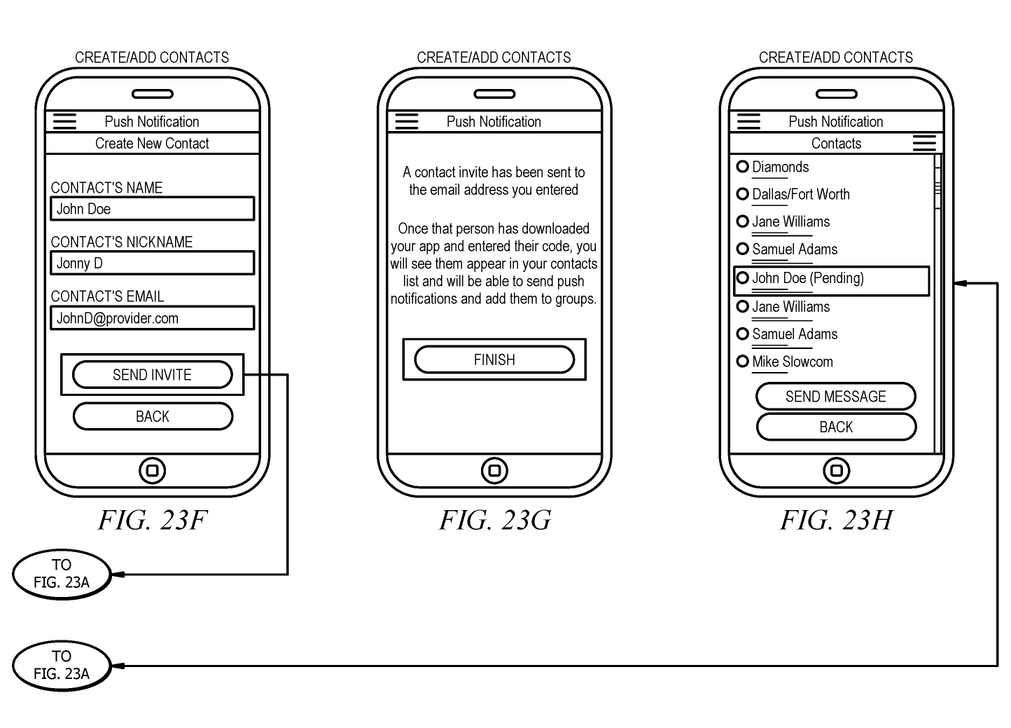

FIG. 23 illustrates a series of screenshots 23A-23H showing a Create/Add Contacts process. Initially, after again entering credentials using the login option in the screen shot of FIG. 23A, the sending subscriber would select from the Push Admin screen (FIG. 23B), and thereafter select the “Contacts” option from the screen shot of FIG. 23C. From the Contacts list screen of FIG. 23D, the subscriber may select the dropdown menu from the screen of FIG. 23E, and from that menu the option to “Add Contact.” A “Create New Contact” screen, shown in FIG. 23F is then displayed, the subscriber may then fill in the intended contact's personal information and select the option to “Send Invite” to that person. In this embodiment of the disclosed platform, the platform takes the contact information provided by the subscriber and generates an invite email that is sent to the intended contact. Once the intended contact accepts the invitation, the new contact would then install the subscriber's unique application on their device, as well as cerate login credentials for their own use. For example, the platform may create a system-generated username and system-generated password for the new contact's use in logging into to the newly install subscriber application. These may be provided via a “Thank You” email returned to the new contact by the system. In other embodiments, the new contact could be prompted to create their own username and/or password. Importantly, as illustrated, the disclosed platform also captures the Device ID of the new contact's computing device on which the subscriber application has been installed in order to associate the new contact's (now a new “user”) Device ID with the installed unique subscriber application as discussed above. The process may again be finished by selecting the “Finish” option from the screen shot of FIG. 23G, and thereafter the application may again return to the Contacts screen as shown in FIG. 23H.

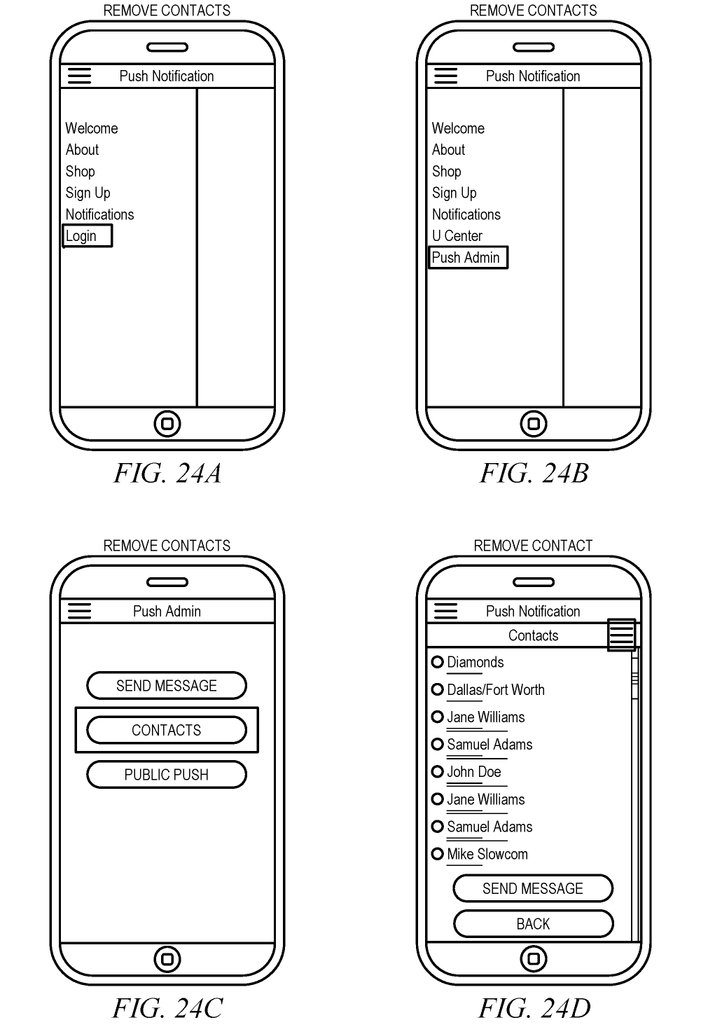

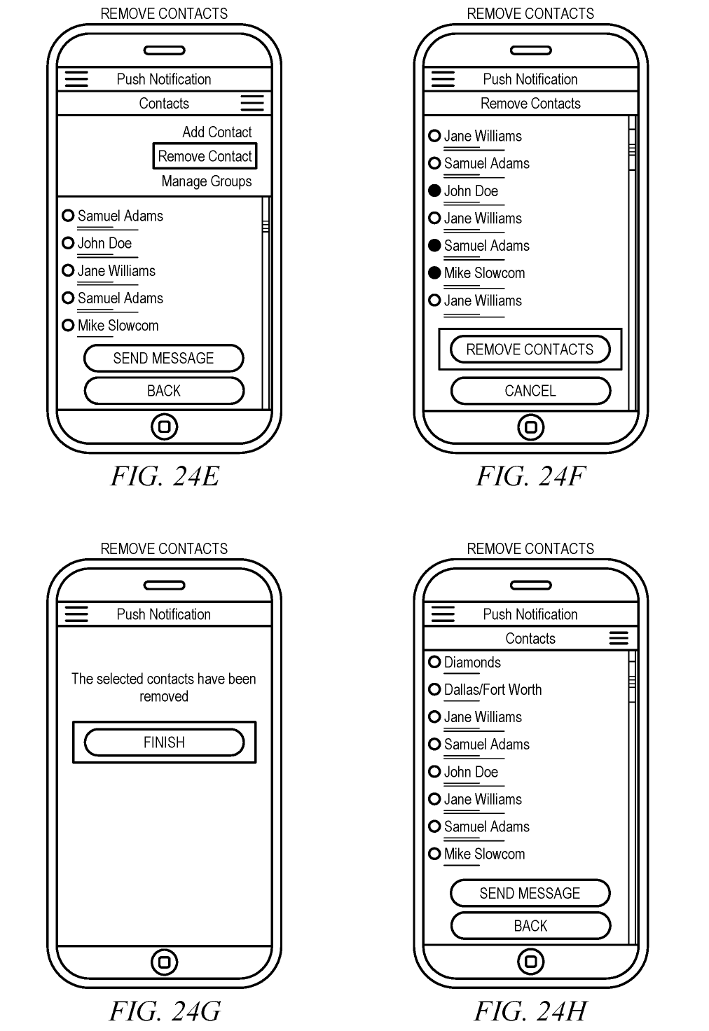

FIG. 24 illustrates a series of screenshots 24A-24H showing a Remove Contacts process. Initially, after again entering credentials using the login option in the screen shot of FIG. 24A, the sending subscriber would select from the Push Admin screen (FIG. 24B), and thereafter may select the “Contacts” option from the screen shot of FIG. 24C. From the Contacts list screen of FIG. 24D, the subscriber may select the dropdown menu from the screen of FIG. 24E, and from that menu the option to “Remove Contact.” A “Remove Contact” screen, shown in FIG. 24F is then displayed, and the subscriber may then select one or more contacts to be removed, and then selects the “remove Contacts” button to remove those contacts. The process may again be finished by selecting the “Finish” option from the screen shot of FIG. 24G, and thereafter the application may again return to the Contacts screen as shown in FIG. 24H.

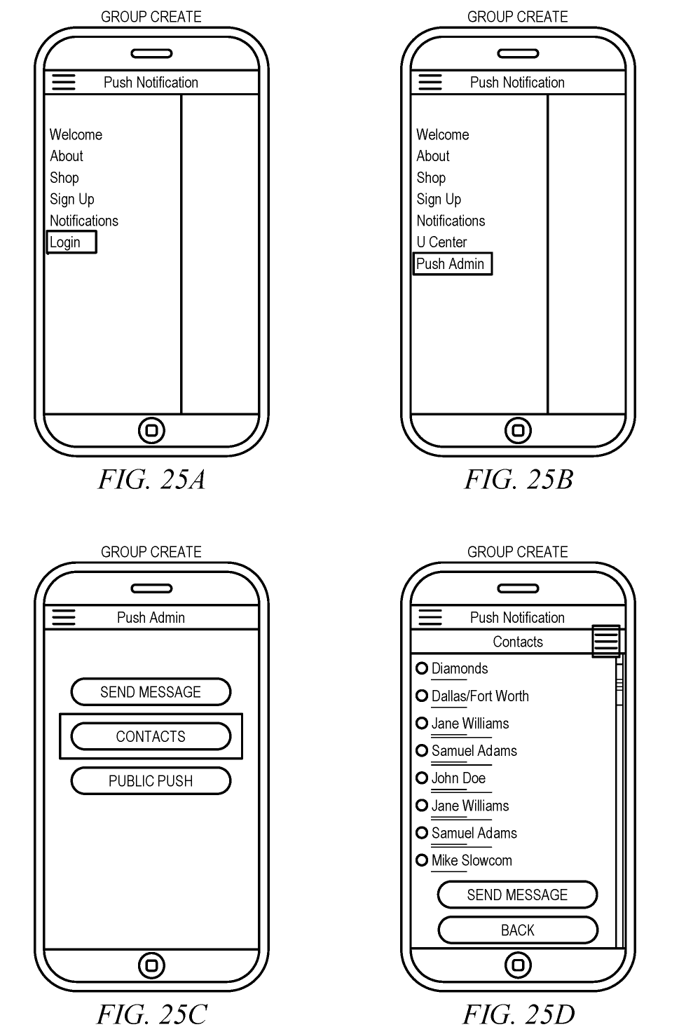

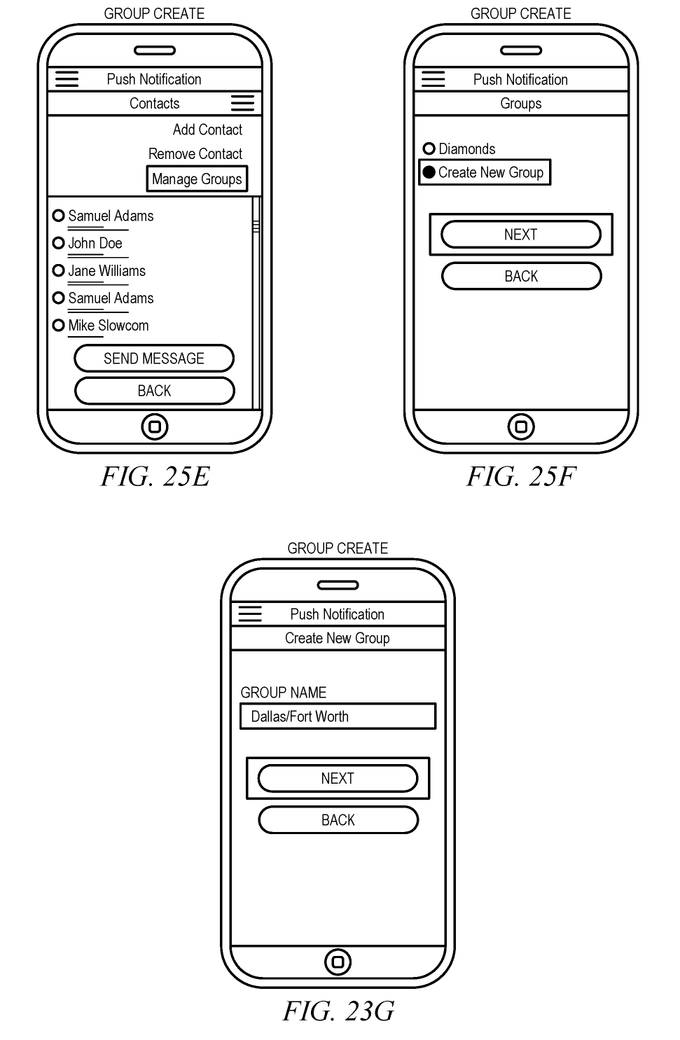

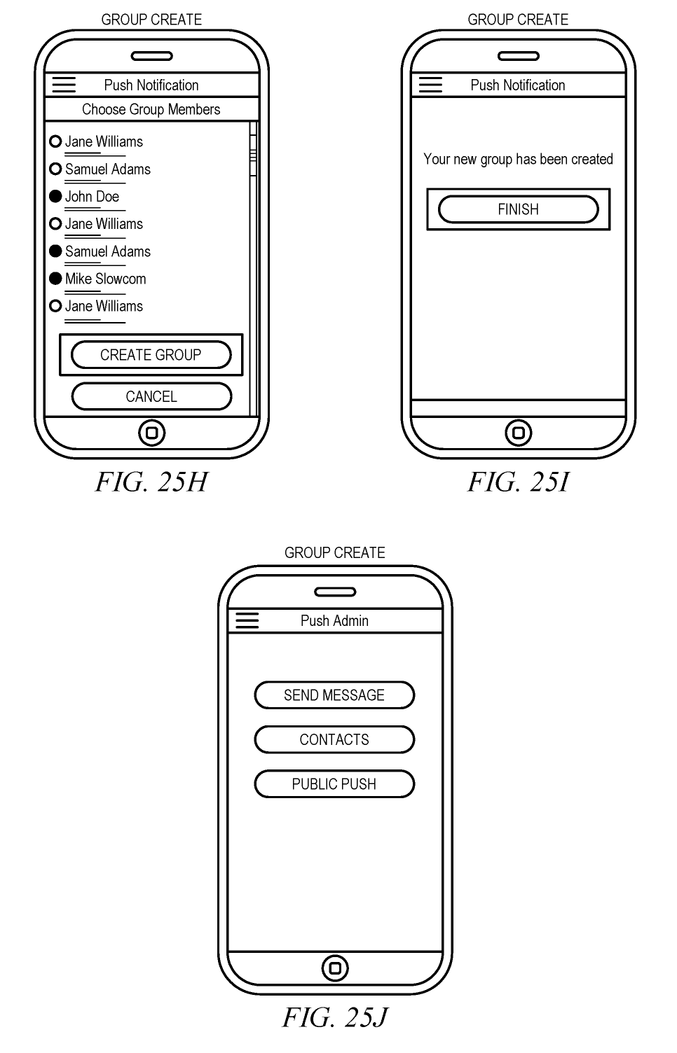

FIG. 25 illustrates a series of screenshots 25A-25J showing a Group Contacts process. Initially, after again entering credentials using the login option in the screen shot of FIG. 25A, the sending subscriber would select from the Push Admin screen (FIG. 25B), and thereafter select the “Contacts” option from the screen shot of FIG. 25C. From the Contacts list screen of FIG. 25D, the subscriber may select the dropdown menu from the screen of FIG. 25E, and from that menu the option to “Manage Groups.” A “Groups” screen, shown in FIG. 25F is then displayed, and the subscriber may then select the option to “Create New Group,” and thereafter press the “Next” button. The subscriber may then type the name for the new group in FIG. 25G, and thereafter press the “Next” button. From the screen shown in FIG. 25H, the subscriber may then select any number of contacts from his contacts list, and thereafter press the “Create Group” button. The process may again be finished by selecting the “Finish” option from the screen shot of FIG. 25I, and thereafter the application may again return to the Push Admin screen as shown in FIG. 25J.

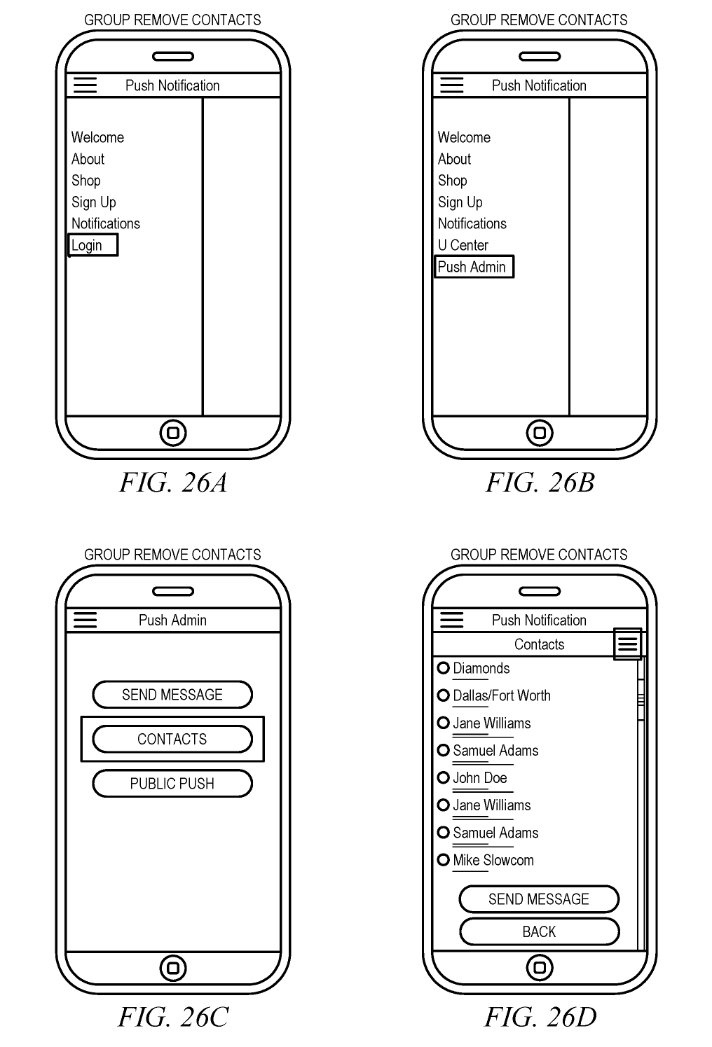

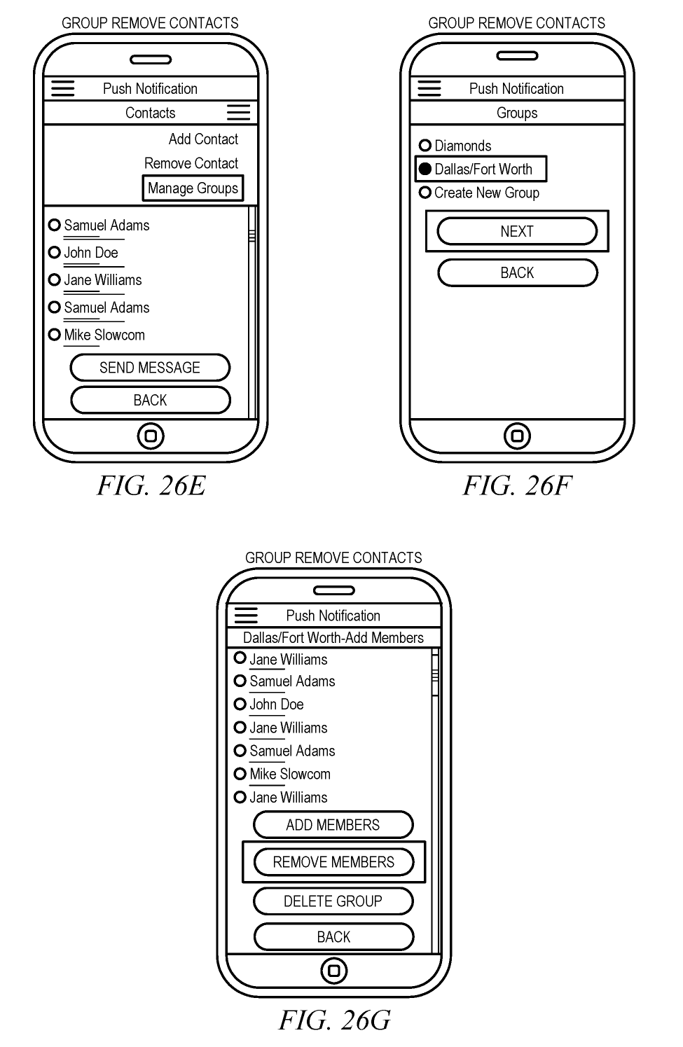

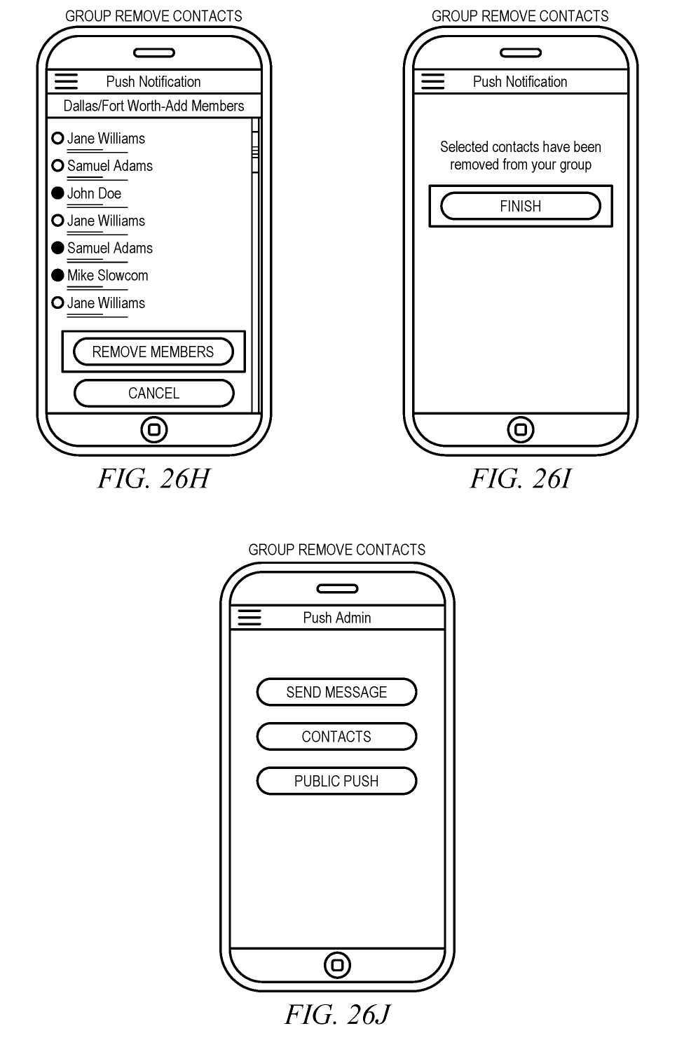

FIG. 26 illustrates a series of screenshots 26A-26J showing a Group Remove Contacts process. Initially, after again entering credentials using the login option in the screen shot of FIG. 26A, the sending subscriber would select from the Push Admin screen (FIG. 26B), and thereafter select the “Contacts” option from the screen shot of FIG. 26C. From the Contacts list screen of FIG. 26D, the subscriber may select the dropdown menu from the screen of FIG. 26E, and from that menu the option to “Manage Groups.” A “Groups” screen, shown in FIG. 26F is then displayed, and the subscriber may then select a particular Group that has previously been created, and thereafter press the “Next” button. The subscriber then has the option to either Add Members to this preexisting Group, Remove Members from this Group, or Delete the Group altogether. In this illustrated embodiment, the subscriber has elected to remove one or more members of the Group, and thus in FIG. 26H he selects which members he would like to remove from this Group. Once his selections have been made, the subscriber then presses the “Remove Members” button. The process may again be finished by selecting the “Finish” option from the screen shot of FIG. 26I, and thereafter the application may again return to the Push Admin screen as shown in FIG. 26J.

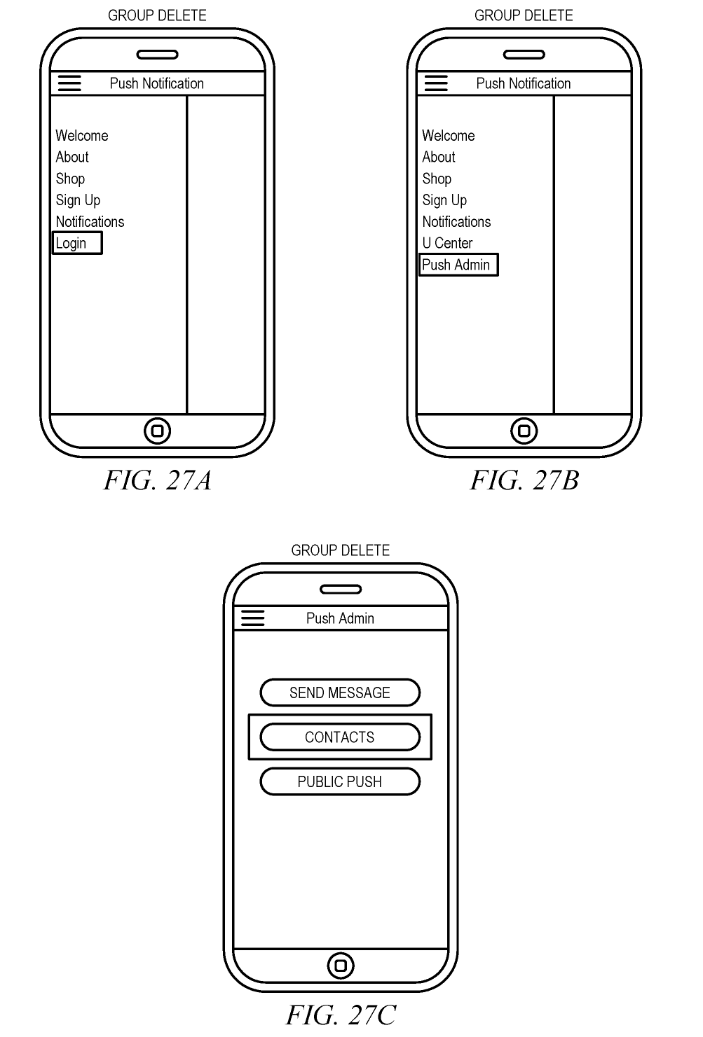

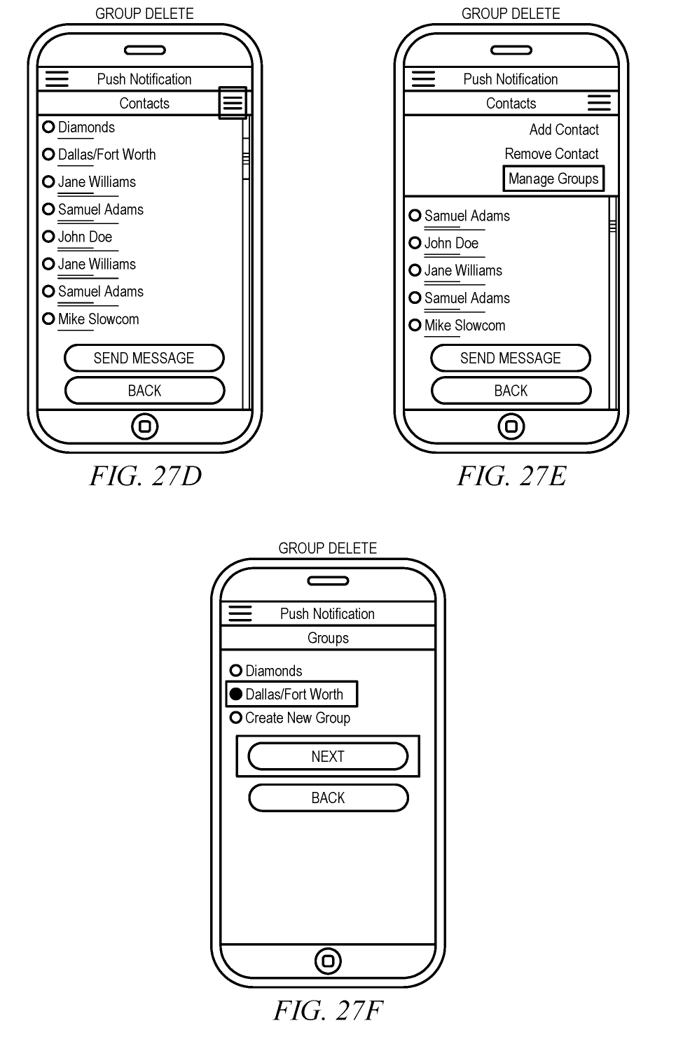

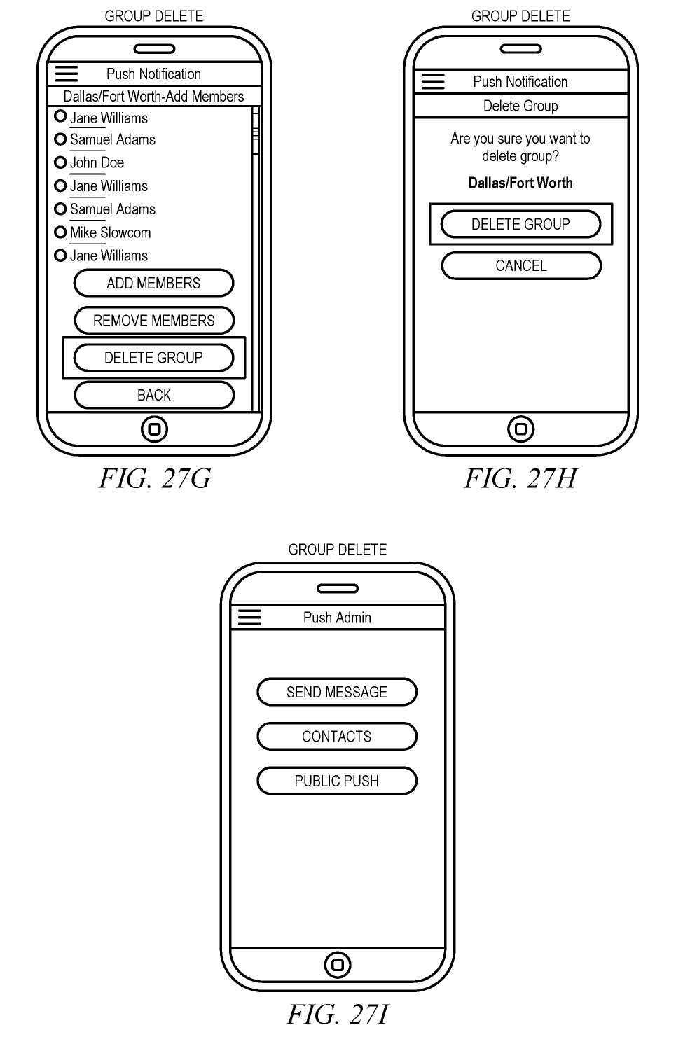

FIG. 27 illustrates a series of screenshots 27A-27I showing a Group Delete process. Initially, after again entering credentials using the login option in the screen shot of FIG. 27A, the sending subscriber would select from the Push Admin screen (FIG. 27B), and thereafter select the “Contacts” option from the screen shot of FIG. 27C. From the Contacts list screen of FIG. 27D, the subscriber may select the dropdown menu from the screen of FIG. 27E, and from that menu the option to “Manage Groups.” The “Groups” screen, shown in FIG. 27F is then displayed, and the subscriber may then select a particular Group that has previously been created, and thereafter press the “Next” button. In this illustrated embodiment, the subscriber has elected to delete the entire selected Group in FIG. 27G. Upon electing to delete this entire Group, the application provides a confirmation screen for the deletion, shown in FIG. 27H. If the subscriber is certain he desires to delete the Group, he then again selects a “Delete Group” button which deletes the entire Group. The process is then finished and the application may again return to the Push Admin screen as shown in FIG. 27I.

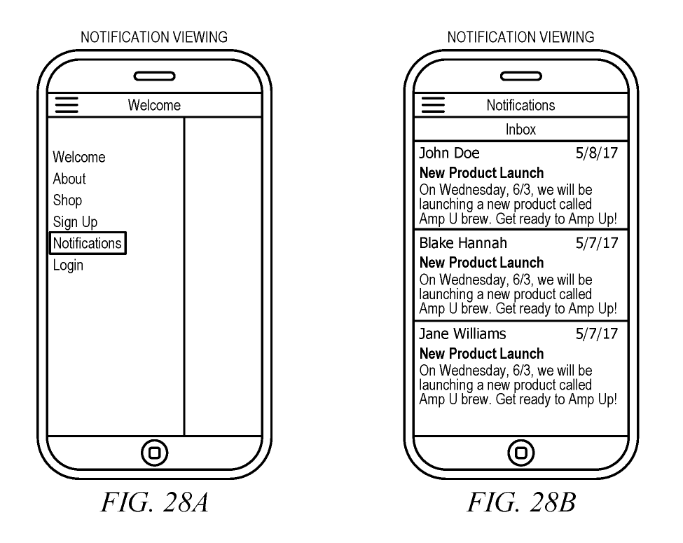

FIG. 28 illustrates a series of screenshots 28A-28B showing a Notification Viewing process. More specifically, these screen shots illustrate a process within a subscriber's application for a subscriber or user of the application to view push notifications received via a platform in accordance with the disclosed principles. After the subscriber or user has signed in with their credentials, as discussed above, a “Notifications” button may be selected as shown in FIG. 28A. Once selected, the application opens a Notifications page, shown in FIG. 28B, which displays the subscriber's/user's notifications Inbox. Typically, the received notifications may be arranged chronologically, which permits the subscriber/user to scroll through his prior received notifications. A drop down menu may also be provided in the application, which would provide options to the subscriber/user to manage those notifications.

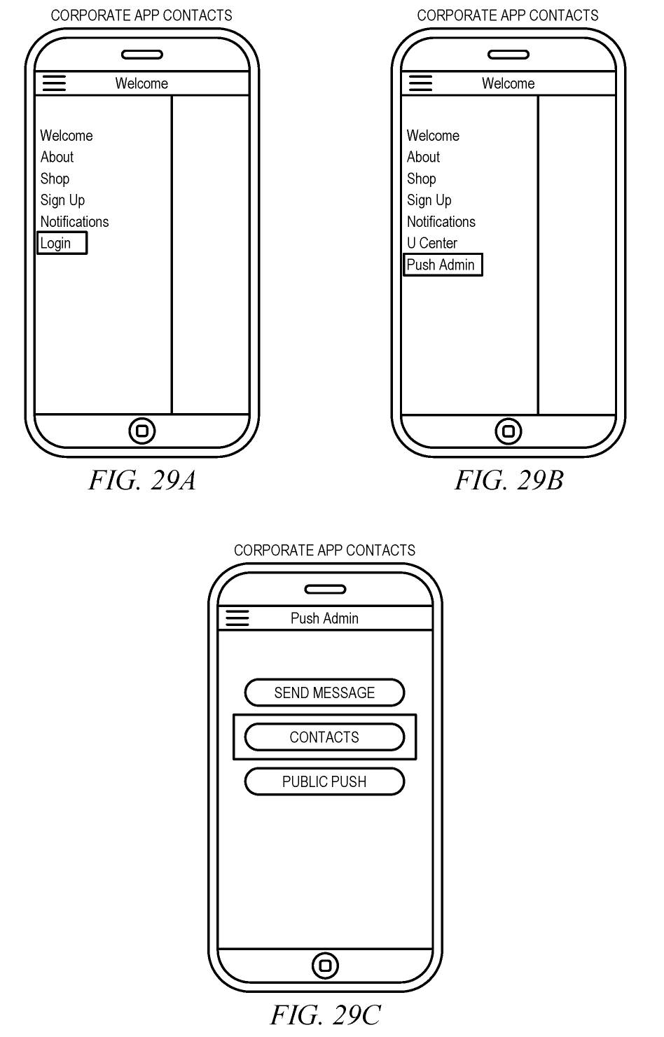

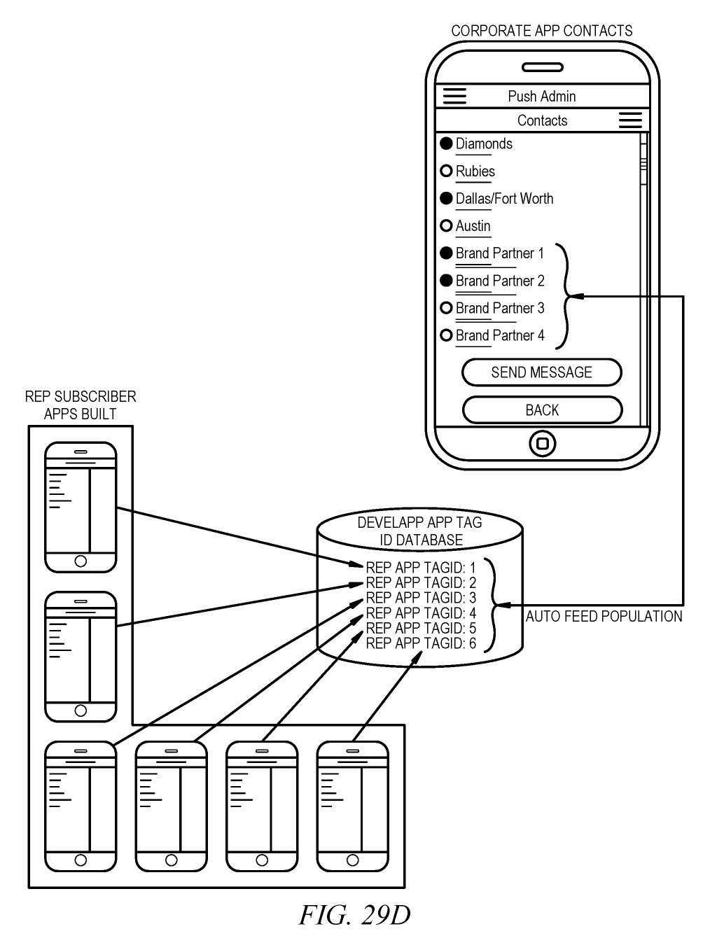

FIG. 29 illustrates a series of screenshots 29A-29D showing a Corporate App Contacts process. After the subscriber or user has again signed in with their credentials using the login option in the screen shot of FIG. 29A, the sending subscriber would select from the Push Admin screen (FIG. 29B), and thereafter may select the “Contacts” option from the screen shot of FIG. 29C. From the Contacts list screen of FIG. 29D, the subscriber may scroll through his list of contacts to select one or more Corporate Contacts, denoted in FIG. 29D as “Brand Partner” 1 through 4. Selecting this Corporate Contacts for sending a push notification causes the sending subscriber's application to communicate with the platform disclosed herein to cross-reference the unique application TAG IDs for each subscriber application of each of the selected Corporate Contacts with the unique Device IDs of user mobile devices having those applications installed thereon. With this feature, the sending subscriber is able to send push notifications not only to the Corporate Contacts' mobile devices (having the sending subscriber's application), but also to users of the subscriber applications built of each of the selected Corporate Contacts.

While the disclosed principles have been particularly shown and described with reference to preferred embodiments, it will be understood by those skilled in the art that various changes in form and detail may be made therein without departing from the spirit and scope of the invention. The inventor expects skilled artisans to employ such variations as appropriate, and the inventors intend the invention to be practiced otherwise than as specifically described herein. Accordingly, the scope of this disclosure includes all modifications and equivalents of the subject matter recited in any claims issuing from this disclosure, as permitted by applicable law. Moreover, any combination of the above-described elements in all possible variations thereof is encompassed by the disclosed principles unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A platform for providing custom push notifications, comprising:
a plurality of applications each uniquely corresponding to a respective plurality of subscribers of said platform, wherein:
each unique application of a corresponding subscriber is configured to be installed and executed on a computing device of said corresponding subscriber, and
each of the plurality of applications is configured to be executed on computing devices of one or more non-subscribing users selectively installing one or more of the plurality of applications on their respective computing devices;
a database configured to store a plurality of unique application tags, each application tag uniquely identifying respective ones of the plurality of applications, and to store unique device IDs, each unique device ID corresponding to respective computing devices of all subscribers and users having one of the plurality of applications installed thereon; and
a processor configured to associate unique device IDs of computing devices having one of the plurality of applications installed thereon with the unique application tag for each computing device's installed application, wherein the processor is further configured to:
receive a request for a push notification from a subscriber via their unique application,
identify one or more user computing devices having said requesting subscriber's unique application installed thereon using associations of the unique application tag assigned to said requesting subscriber's unique application and the unique device IDs, and
cause said push notification to be sent to one or more of the identified user computing devices via the requesting subscriber's unique application installed thereon.

2. A platform in accordance with claim 1, wherein the requesting subscriber's unique application installed on the one or more identified user computing devices receiving said push notification have been selectively configured to receive said push notification.

3. A platform in accordance with claim 2, wherein said selective configuration is providable by respective users of the one or more identified user computing devices receiving said push notification.

4. A platform in accordance with claim 1, wherein the one or more identified user computing devices receiving said push notification via the requesting subscriber's unique application have been selected by the requesting subscriber via his unique application installed on his computing device.

5. A platform in accordance with claim 1, wherein the processor causes said push notification to be sent to all of the identified user computing devices having the requesting subscriber's unique application installed thereon.

6. A platform in accordance with claim 5, wherein the requesting subscriber's unique application installed on the one or more identified user computing devices receiving said push notification are required to receive said push notification as a condition of said installation.

7. A platform in accordance with claim 1, wherein the processor causes said push notification to be sent from a push notification service independent from said platform.

8. A platform in accordance with claim 1, wherein the unique device IDs comprise unique device IMEI numbers corresponding to the subscriber and user computing devices.

9. A platform in accordance with claim 1, wherein one or more of the unique applications comprise an online store associated with corresponding one or more subscribers.

10. A platform in accordance with claim 1, wherein the processor is further configured to assign each of the unique application tags to each of the plurality of applications.

11. A method for providing custom push notifications, comprising:
providing a plurality of applications each uniquely corresponding to a respective plurality of subscribers of said platform, wherein:
each unique application of a corresponding subscriber is configured to be installed and executed on a computing device of said corresponding subscriber, and
each of the plurality of applications is configured to be executed on computing devices of one or more non-subscribing users selectively installing one or more of the plurality of applications on their respective computing devices;
storing a plurality of unique application tags, each application tag uniquely identifying respective ones of the plurality of applications;
storing unique device IDs, each unique device ID corresponding to respective computing devices of all subscribers and users having one of the plurality of applications installed thereon;
associating unique device IDs of computing devices having one of the plurality of applications installed thereon with the unique application tag for each computing device's installed application;
receiving a request for a push notification from a subscriber via their unique application;
identifying one or more user computing devices having said requesting subscriber's unique application installed thereon using associations of the unique application tag assigned to said requesting subscriber's unique application and the unique device IDs; and
causing said push notification to be sent to one or more of the identified user computing devices via the requesting subscriber's unique application installed thereon.

12. A method in accordance with claim 11, wherein the requesting subscriber's unique application installed on the one or more identified user computing devices receiving said push notification have been selectively configured to receive said push notification.

13. A method in accordance with claim 12, wherein said selective configuration is providable by respective users of the one or more identified user computing devices receiving said push notification.

14. A method in accordance with claim 11, wherein the one or more identified user computing devices receiving said push notification via the requesting subscriber's unique application have been selected by the requesting subscriber via his unique application installed on his computing device.

15. A method in accordance with claim 11, wherein causing said push notification to be sent further comprises causing said push notification to be sent to all of the identified user computing devices having the requesting subscriber's unique application installed thereon.

16. A method in accordance with claim 15, wherein the requesting subscriber's unique application installed on the one or more identified user computing devices receiving said push notification are required to receive said push notification as a condition of said installation.

17. A method in accordance with claim 11, wherein causing said push notification to be sent further comprises causing said push notification to be sent from a push notification service independent from said platform.

18. A method in accordance with claim 11, wherein the unique device IDs comprise unique device IMEI numbers corresponding to the subscriber and user computing devices.

19. A method in accordance with claim 11, wherein one or more of the unique applications comprise an online store associated with corresponding one or more subscribers.

20. A method in accordance with claim 11, further comprising assigning each of the stored unique application tags to each of the plurality of applications.
